(19) United States
(12) Patent Application Publication
(10) Pub. No.: US 2024/0320392 A1
(43) Pub. Date: Sep. 26, 2024

(54) SYSTEMS AND METHODS FOR THREE-DIMENSIONAL BODY PART MODELLING

(71) Applicant: Proxamama, Inc., Las Vegas, NV (US)

(72) Inventors: Francis Bitonti, Las Vegas, NV (US); Sagiv Daniel, Tel Aviv (IL)

(21) Appl. No.: 18/615,561

(22) Filed: Mar. 25, 2024

Related U.S. Application Data
(60) Provisional application No. 63/495,518, filed on Apr. 11, 2023.
(60) Provisional application No. 63/491,852, filed on Mar. 23, 2023.

(51) Int. Cl. G06F 30/20

(52) U.S. Cl. CPC G06F 30/20

(57) ABSTRACT

A method includes scanning a user's body part via a user computing device to generate data points that each include depth and positional information of a point on the body part in the scan. A three-dimensional (3D) model of the body is generated based at least in part on the plurality of data points and at least one portion of the 3D model having at least one error is identified based at least in part on the plurality of data points. The plurality of data points are modified to rebuild the 3D model with at least one rebuilt portion in place of the at least one portion having the at least one error.

### FIELD OF INVENTION

The present disclosure relates generally to three-dimensional modelling of body parts. Specifically, the present disclosure relates to methods of customizing three dimensional models for individuals.

### BACKGROUND

Feeding devices, such as baby bottles, are often used to feed babies from newborns to toddlers for various reasons. Reasons for using a feeding device include, but are not limited to: latching difficulties by the baby, inability for the mother to produce enough milk, feeding by a caregiver or physician other than the mother, inability for the mother to breastfeed for health reasons, weaning of the baby, etc.

### SUMMARY OF THE INVENTION

The summary is a high-level overview of various aspects of the invention and introduces some of the concepts that are further detailed in the Detailed Description section below. This summary is not intended to identify key or essential features of the claimed subject matter, nor is it intended to be used in isolation to determine the scope of the claimed subject matter. The subject matter should be understood by reference to the appropriate portions of the entire specification, any or all drawings, and each claim.

In some aspects, the techniques described herein relate to a method including: receiving, by one or more processors, from a camera, at least one image of a body part; generating, by the one or more processors, a plurality of data points that each include depth and positional information of a point on the body part in the at least one image; generating, by the one or more processors, a three-dimensional (3D) model of the body based at least in part on the plurality of data points; determining, by the one or more processors, at least one portion of the 3D model having at least one error based at least in part on the plurality of data points; modifying, by the one or more processors, the plurality of data points to rebuild the 3D model with at least one rebuilt portion in place of the at least one portion having the at least one error.

In some aspects, the techniques described herein relate to a method, further including: applying, by the one or more processors, a marching cubes algorithm to rebuild the 3D model.

In some aspects, the techniques described herein relate to a method, further including: causing, by the one or more processors, a client device including the camera to display the at least one image; and generating, by the one or more processors, an indicator to indicate a region of interest including the body part in the plurality of images of the at least one image.

In some aspects, the techniques described herein relate to a method, further including: causing, by the one or more processors, a client device including the camera to display the at least one image; and generating, by the one or more processors, responsive to not detecting the body part in the at least one image, a notification requesting a user to maneuver the camera.

In some aspects, the techniques described herein relate to a method, further including: transmitting, by the one or more processors, to a body part analysis server, the plurality of data points; and receiving, by the one or more processors, from the body part analysis server, a fitment category and/or a color to produce a user-specific fitment fitted to the body part in the at least one image.

In some aspects, the techniques described herein relate to a method, further including: generating, by the one or more processors, at least one notification to a client device, the at least one notification including: indicating the at least one error in the at least one portion, and an instruction to retake the at least one image.

In some aspects, the techniques described herein relate to a method, wherein the 3D model includes a point cloud.

In some aspects, the techniques described herein relate to a method, wherein the at least one error includes at least one of: noise, at least one blind spot, or at least one measurement error.

In some aspects, the techniques described herein relate to a method, further including: generating, by the one or more processors, an outline of the 3D model along a lateral profile of the body part; and rebuilding, by the one or more processors, the at least one portion of the 3D model by rotating the outline around the 3D model to define the lateral profile at the at least one portion.

In some aspects, the techniques described herein relate to a system including: receive, from a camera, at least one image of a body part; generate a plurality of data points that each include depth and positional information of a point on the body part in the at least one image; generate a three-dimensional (3D) model of the body based at least in part on the plurality of data points; determine at least one portion of the 3D model having at least one error based at least in part on the plurality of data points; and modify the plurality of data points to rebuild the 3D model with at least one rebuilt portion in place of the at least one portion having the at least one error.

In some aspects, the techniques described herein relate to a system, wherein the at least one processor is further configured to: apply a marching cubes algorithm to rebuild the 3D model.

In some aspects, the techniques described herein relate to a system, wherein the at least one processor is further configured to: cause, a client device including the camera to display the at least one image; and generate, an indicator to indicate a region of interest including the body part in the plurality of images of the at least one image.

In some aspects, the techniques described herein relate to a system, wherein the at least one processor is further configured to: cause, a client device including the camera to display the at least one image; and generate, responsive to not detecting the body part in the at least one image, a notification requesting a user to maneuver the camera.

In some aspects, the techniques described herein relate to a system, wherein the at least one processor is further configured to: transmit, to a body part analysis server, the plurality of data points; and receive, from the body part analysis server, a fitment category and/or a color to produce a user-specific fitment fitted to the body part in the at least one image.

In some aspects, the techniques described herein relate to a system, wherein the at least one processor is further configured to: generate at least one notification to a client device, the at least one notification including: indicating the at least one error in the at least one portion, and an instruction to retake the at least one image.

In some aspects, the techniques described herein relate to a system, wherein the 3D model includes a point cloud.

In some aspects, the techniques described herein relate to a system, wherein the at least one error includes at least one of: noise, at least one blind spot, or at least one measurement error.

In some aspects, the techniques described herein relate to a system, wherein the at least one processor is further configured to: generate an outline of the 3D model along a lateral profile of the body part; and rebuild the at least one portion of the 3D model by rotating the outline around the 3D model to define the lateral profile at the at least one portion.

Embodiments of the present disclosure relate to a method including scanning, by one or more processors, a user's nipple via a user computing device to generate a scan image. The method also includes applying, by the one or more processors, a machine learning engine to the scan image to identify the user's nipple within the image scan. The method also includes generating, by the one or more processors, an output scan image via the machine learning engine, where the output scan image includes one or more features identifying the user's nipple within the output scan image. The method also includes applying, by the one or more processors, an algorithm to the output scan image to generate a three-dimensional (3D) image of the user's nipple, where the algorithm employs at least one genetic process and where the 3D image of the user's nipple is a baby bottle nipple profile. The method also includes transmitting, by the one or more processors, the 3D image of the user's nipple to a second user computing device for 3D printing of a custom baby bottle nipple, where the custom baby bottle nipple is a 3D replication of the user's nipple.

In some embodiments, the method further includes training, by the one or more processors, the machine learning engine to identify a nipple within a scan image based at least in part on a set of images comprising at least a portion of a nipple of a human.

In some embodiments, the scan image is a video comprising at least two image frames.

In some embodiments, the machine learning engine is trained to identify the nipple within each frame of the scan image.

In some embodiments, the method further includes prompting, by the one or more processors, the user to rescan the nipple if the machine learning engine does not identify a nipple within each frame of the scan image.

In some embodiments, the method further includes gathering and creating a point cloud, by the one or more processors, by stitching each image frame of the scan image together.

In some embodiments, a first genetic process of the at least one genetic process includes orienting, by the one or more processors, the point cloud from the scan image with a teat of the user's nipple in a predetermined direction.

In some embodiments, the predetermined direction is along a positive z axis.

In some embodiments, a second genetic process of the at least one genetic process includes setting, by the one or more processors, an average normal at a top portion of the point cloud as close to the positive z axis as possible.

In some embodiments, a third genetic process of the at least one genetic process includes maximizing, by the one or more processors, a height at which the teat exceeds a predetermined cross-sectional diameter.

In some embodiments, the predetermined cross-sectional diameter is 30 mm.

In some embodiments, the algorithm filters out a normal of each point in the point cloud further and further away from the positive z axis, until there is a clear separation between the teat and a base of the user's nipple.

In some embodiments, the method further includes rebuilding, by the one or more processors, the user's nipple without any gaps or holes by extracting one or more contours and measurements from the image scan.

In some aspects, the techniques described herein relate to a method including: receiving, by one or more processors, from a camera, an image stream; applying, by the one or more processors, a trained nipple detection machine-learning model to: generate a plurality of data points that each include depth and positional information of a breast in each image of the image stream; generate a plurality of vectors that are representative of a curvature and rate of change across the breast in each image of the image stream; classify the plurality of data points and the plurality of vectors to identify a region of interest including a digital representation of a nipple in a plurality of images of the image stream to a plurality of reference images in a corpus of reference images of a plurality of nipples; and identifying, by the one or more processors, based on (i) the plurality of images classified to the plurality of reference images, (ii) the plurality of data points, and (iii) the plurality of vectors, a mouthpiece category and/or a color to produce a user-specific baby bottle having a bottle nipple corresponding to the breast in the image stream.

In some aspects, the techniques described herein relate to a method, wherein classifying the region of interest includes: extracting, by the one or more processors, a plurality of features from the plurality of images; and classify, based on the plurality of data points and the plurality of vectors, the region of interest including the nipple in the plurality of features to the plurality of reference images in a corpus of reference images of a plurality of nipples.

In some aspects, the techniques described herein relate to a method, wherein classifying the region of interest includes: identifying, by the one or more processors, a probability distribution of the plurality of images; generating, by the one or more processors, a subset of the plurality of images based on the probability distribution; and classify, based on the plurality of data points and the plurality of vectors, the region of interest including the nipple in the subset of the plurality of images to the plurality of reference images in a corpus of reference images of a plurality of nipples.

In some aspects, the techniques described herein relate to a method, further including: causing, by the one or more processors, a client device including the camera to display the image stream; and generating, by the one or more processors, an indicator to indicate the region of interest including the nipple in the plurality of images of the image stream.

In some aspects, the techniques described herein relate to a method, further including: causing, by the one or more processors, a client device including the camera to display the image stream; and generating, by the one or more processors, responsive to not detecting the nipple in the image stream, a notification requesting a user to maneuver the client device including the camera.

In some aspects, the techniques described herein relate to a method, further including: transmitting, by the one or more processors, to a nipple analysis server, the plurality of images classified to the plurality of reference images, the plurality of data points, and the plurality of vectors; and receiving, by the one or more processors, from the nipple analysis server, a mouthpiece category and/or a color to produce a user-specific baby bottle having a bottle nipple corresponding to the breast in the image stream.

In some aspects, the techniques described herein relate to a method, further including: generating, by the one or more processors, software instructions that include the mouthpiece category and/or the color for producing the user-specific baby bottle; and transmitting, by the one or more processors, the software instructions that include the mouthpiece category and/or the color to cause production of the user-specific baby bottle.

In some aspects, the techniques described herein relate to a method, further including: causing, by the one or more processors, a client device including the camera to display the user-specific baby bottle to a user.

In some aspects, the techniques described herein relate to a method, further including: receiving, by the one or more processors, a selection of the color of the user-specific baby bottle.

In some aspects, the techniques described herein relate to a method, further including: training, by the one or more processors, the trained nipple detection machine-learning model designed to identity a human nipple by: receiving a training dataset including previously captured images; wherein each image includes a particular visual imagery of a particular human nipple of a particular woman from a population of at least one-hundred women; feeding the training dataset into the trained nipple detection machine-learning model; wherein the nipple detection machine-learning model is being trained to recognize each human nipple based on a set of identified landmarks featured in each image, by: laying over the particular visual imagery of the particular image over a 3D model of the human nipple, matching the set of identified landmarks to the 3D model of the human nipple, and generating a predicative output identifying a particular human nipple in the particular imagery of the particular image; generating a confidence score based on matching the predictive output of the trained nipple detection machine learn model to a ground truth of the particular human nipple identified by a fiducial marker on a region of interest in the particular imagery of the particular image; re-training, in real-time, the trained nipple detection machine-learning model until the confidence score meets a predetermined threshold to obtain the trained nipple detection machine-learning model by: utilizing the nipple detection machine-learning model to, in real-time, identify, with a new fiducial marker, a new region of interest in a new visual representation of a new view of a camera; wherein the new region of interest includes a new particular human nipple of a new woman that is outside of the population; detecting at least one change in a position of the new fiducial marker: wherein the at least one change in the position is to enhance an alignment of the new fiducial marker with the new region of interest; automatically modify, based on the at least one change, at least one weight of at least one parameter of the nipple detection machine-learning model; and wherein the confidence score corresponds to the at least one change in the position.

In some aspects, the techniques described herein relate to a method including: receiving, by one or more processors, from a camera, a plurality of images of a breast that includes a nipple in a region of interest in the plurality of images, a plurality of data points that each include depth and positional information of the breast and the nipple in each image of the plurality of images, and a plurality of vectors representative of a curvature and rate of change across the breast and the nipple in each image of the plurality of images, the plurality of images generated by the client device from an image stream of the nipple captured by the camera; generating, by the one or more processors, a three-dimensional (3D) image of the breast from the plurality of images based on the plurality of data points and the plurality of vectors; identifying, by the one or more processors, a confidence score of the 3D image based on the plurality of images, the plurality of data points, and the plurality of vectors; applying, by the one or more processors, responsive to the confidence score satisfying a predetermined threshold, a trained nipple analysis machine-learning model to: extract a plurality of geometric markers of the nipple in the region of interest in the 3D image; generate, based on the plurality of geometric markers, a modified 3D image by modifying the 3D image to a plurality of reference images in a corpus of reference images of a plurality of nipples; determining, by the one or more processors, a mouthpiece category of a baby bottle mouthpiece based on the plurality of geometric markers; and identifying, by the one or more processors, based on the mouthpiece category and/or a color of the baby bottle mouthpiece, a user-specific baby bottle having the baby bottle mouthpiece.

In some aspects, the techniques described herein relate to a method, wherein classifying the region of interest includes: extracting, by the one or more processors, a plurality of features from the plurality of images; and classify, based on the plurality of data points and the plurality of vectors, the region of interest including the nipple in the plurality of features to the plurality of reference images in a corpus of reference images of a plurality of nipples.

In some aspects, the techniques described herein relate to a method, wherein classifying the region of interest includes: identifying, by the one or more processors, a probability distribution of the plurality of images; generating, by the one or more processors, a subset of the plurality of images based on the probability distribution; and classify, based on the plurality of data points and the plurality of vectors, the region of interest including the nipple in the subset of the plurality of images to the plurality of reference images in a corpus of reference images of a plurality of nipples.

In some aspects, the techniques described herein relate to a method, further including: causing, by the one or more processors, a client device including the camera to display the image stream; and generating, by the one or more processors, an indicator to indicate the region of interest including the nipple in the plurality of images of the image stream.

In some aspects, the techniques described herein relate to a method, further including: causing, by the one or more processors, a client device including the camera to display the image stream; and generating, by the one or more processors, responsive to not detecting the nipple in the image stream, a notification requesting a user to maneuver the client device including the camera.

In some aspects, the techniques described herein relate to a method, wherein the plurality of images are received from a client device including the camera, and further including: transmitting, by the one or more processors, to the client device for display, the mouthpiece category according to the plurality of geometric markers and/or the color to produce the user-specific baby bottle.

In some aspects, the techniques described herein relate to a method, further including: generating, by the one or more processors, software instructions that include the mouthpiece category and/or the color for producing the user-specific baby bottle; and transmitting, by the one or more processors, the software instructions that include the mouthpiece category and/or the color to cause production of the user-specific baby bottle.

In some aspects, the techniques described herein relate to a method, further including: causing, by the one or more processors, a client device including the camera to display the user-specific baby bottle to a user.

In some aspects, the techniques described herein relate to a method, wherein applying the trained nipple analysis machine-learning model includes: identify a base diameter and a teat diameter of the nipple in the region of interest in the 3D image; generate, based on the base diameter and the teat diameter of the nipple, a modified 3D image by classifying the 3D image to a plurality of reference images in a corpus of reference images of a plurality of nipples.

In some aspects, the techniques described herein relate to a method, further including: identifying, by the one or more processors, in the modified 3D image, a color marker of a plurality of color markers; and determining, by the one or more processors, the color of the baby bottle mouthpiece according to the color marker.

In some aspects, the techniques described herein relate to a method, further including: receiving, by the one or more processors, a selection of the color of the baby bottle mouthpiece.

In some aspects, the techniques described herein relate to a method, further including: training, by the one or more processors, the trained nipple detection machine-learning model designed to identity a human nipple by: receiving a training dataset including previously captured images; wherein each image includes a particular visual imagery of a particular human nipple of a particular woman from a population of at least one-hundred women; feeding the training dataset into the trained nipple detection machine-learning model; wherein the nipple detection machine-learning model is being trained to recognize each human nipple based on a set of identified landmarks featured in each image, by: laying over the particular visual imagery of the particular image over a 3D model of the human nipple, matching the set of identified landmarks to the 3D model of the human nipple, and generating a predicative output identifying a particular human nipple in the particular imagery of the particular image; generating a confidence score based on matching the predictive output of the trained nipple detection machine learn model to a ground truth of the particular human nipple identified by a fiducial marker on a region of interest in the particular imagery of the particular image; re-training, in real-time, the trained nipple detection machine-learning model until the confidence score meets a predetermined threshold to obtain the trained nipple detection machine-learning model by: utilizing the nipple detection machine-learning model to, in real-time, identify, with a new fiducial marker, a new region of interest in a new visual representation of a new view of a camera; wherein the new region of interest includes a new particular human nipple of a new woman that is outside of the population; detecting at least one change in a position of the new fiducial marker: wherein the at least one change in the position is to enhance an alignment of the new fiducial marker with the new region of interest; automatically modify, based on the at least one change, at least one weight of at least one parameter of the nipple detection machine-learning model; and wherein the confidence score corresponds to the at least one change in the position.

In some aspects, the techniques described herein relate to a method including: receiving, by one or more processors, from a camera, an image stream; applying, by the one or more processors, a trained nipple detection machine-learning model to: generate a plurality of data points that each include depth and positional information of a breast in each image of the image stream; generate a plurality of vectors that are representative of a curvature and rate of change across the breast in each image of the image stream; classify the plurality of data points and the plurality of vectors to identify a region of interest including a digital representation of a nipple in a plurality of images in the image stream to a plurality of nipple images in a corpus of nipple images of a plurality of nipples; generating, by the one or more processors, a three-dimensional (3D) image of the breast including the digital representation of the nipple from the plurality of images based on the plurality of data points and the plurality of vectors; identifying, by the one or more processors, a confidence score of the 3D image based on the plurality of images, the plurality of data points, and the plurality of vectors; applying, by the one or more processors, responsive to the confidence score satisfying a predetermined threshold, a trained nipple analysis machine-learning model to: extract a plurality of geometric markers of the nipple in the region of interest in the 3D image; generate, based on the plurality of geometric markers, a modified 3D image by modifying the 3D image to a plurality of geometric images in a corpus of geometric images of a plurality of nipples; determining, by the one or more processors, a mouthpiece category of a baby bottle mouthpiece based on the plurality of geometric markers; and identifying, by the one or more processors, based on the mouthpiece category and/or the color of the baby bottle mouthpiece, a user-specific baby bottle having the baby bottle mouthpiece.

In some aspects, the techniques described herein relate to a method, wherein classifying the region of interest includes: extracting, by the one or more processors, a plurality of features from the plurality of images; and classify, based on the plurality of data points and the plurality of vectors, the region of interest including the nipple in the plurality of features to the plurality of reference images in a corpus of reference images of a plurality of nipples.

In some aspects, the techniques described herein relate to a method, wherein classifying the region of interest includes: identifying, by the one or more processors, a probability distribution of the plurality of images; generating, by the one or more processors, a subset of the plurality of images based on the probability distribution; and classify, based on the plurality of data points and the plurality of vectors, the region of interest including the nipple in the subset of the plurality of images to the plurality of reference images in a corpus of reference images of a plurality of nipples.

In some aspects, the techniques described herein relate to a method, further including: causing, by the one or more processors, a client device including the camera to display the image stream; and generating, by the one or more processors, an indicator to indicate the region of interest including the nipple in the plurality of images of the image stream.

In some aspects, the techniques described herein relate to a method, further including: causing, by the one or more processors, a client device including the camera to display the image stream; and generating, by the one or more processors, responsive to not detecting the nipple in the image stream, a notification requesting a user to maneuver the client device including the camera.

In some aspects, the techniques described herein relate to a method, wherein the plurality of images are received from a client device including the camera, and further including: transmitting, by the one or more processors, to the client device for display, the mouthpiece category according to the plurality of geometric markers and/or the color to produce a customized baby bottle.

In some aspects, the techniques described herein relate to a method, further including: generating, by the one or more processors, software instructions that include the mouthpiece category and/or the color for producing the user-specific baby bottle; and transmitting, by the one or more processors, the software instructions that include the mouthpiece category and/or the color to cause production of the user-specific baby bottle.

In some aspects, the techniques described herein relate to a method, further including: causing, by the one or more processors, a client device including the camera to display the user-specific baby bottle to a user.

In some aspects, the techniques described herein relate to a method, wherein applying the trained nipple analysis machine-learning model includes: identify a base diameter and a teat diameter of the nipple in the region of interest in the 3D image; generate, based on the base diameter and the teat diameter of the nipple, a modified 3D image by classifying the 3D image to a plurality of reference images in a corpus of reference images of a plurality of nipples.

In some aspects, the techniques described herein relate to a method, further including: identifying, by the one or more processors, in the modified 3D image, a color marker of a plurality of color markers; and determining, by the one or more processors, the color of the baby bottle mouthpiece according to the color marker.

In some aspects, the techniques described herein relate to a method, further including: receiving, by the one or more processors, a selection of the color of the baby bottle mouthpiece.

In some aspects, the techniques described herein relate to a method, further including: training, by the one or more processors, the trained nipple detection machine-learning model designed to identity a human nipple by: receiving a training dataset including previously captured images; wherein each image includes a particular visual imagery of a particular human nipple of a particular woman from a population of at least one-hundred women; feeding the training dataset into the trained nipple detection machine-learning model; wherein the nipple detection machine-learning model is being trained to recognize each human nipple based on a set of identified landmarks featured in each image, by: laying over the particular visual imagery of the particular image over a 3D model of the human nipple, matching the set of identified landmarks to the 3D model of the human nipple, and generating a predicative output identifying a particular human nipple in the particular imagery of the particular image; generating a confidence score based on matching the predictive output of the trained nipple detection machine learn model to a ground truth of the particular human nipple identified by a fiducial marker on a region of interest in the particular imagery of the particular image; re-training, in real-time, the trained nipple detection machine-learning model until the confidence score meets a predetermined threshold to obtain the trained nipple detection machine-learning model by: utilizing the nipple detection machine-learning model to, in real-time, identify, with a new fiducial marker, a new region of interest in a new visual representation of a new view of a camera; wherein the new region of interest includes a new particular human nipple of a new woman that is outside of the population; detecting at least one change in a position of the new fiducial marker: wherein the at least one change in the position is to enhance an alignment of the new fiducial marker with the new region of interest; automatically modify, based on the at least one change, at least one weight of at least one parameter of the nipple detection machine-learning model; and wherein the confidence score corresponds to the at least one change in the position.

In some aspects, the techniques described herein relate to a method including: receiving, by one or more processors, a mouthpiece category according to a plurality of geometric markers and a color according to a plurality of color markers; generating, by the one or more processors, software instructions that include the mouthpiece category and/or the color for producing a customized baby bottle; and transmitting, by the one or more processors, the software instructions that include the mouthpiece category and/or the color to cause production of the customized baby bottle.

In some aspects, the techniques described herein relate to a method including: instructing, by one or more processors, a camera of a mobile device to obtain a 3D image of a user's nipple; receiving, by the one or more processors, from a camera of a mobile device, a plurality of scanned images; applying, by the one or more processors, an object detection model of a machine learning engine to the plurality of scanned images to identify a user's nipple within the plurality of scanned images based on a plurality of object feature vectors; generating, by the one or more processors, a scan image output including a plurality of object feature vectors identifying the user's nipple; applying, by the one or more processors, an algorithm to extract a plurality of geometric features from the scan image output; wherein the plurality of geometric features identifies: nipple-related height, nipple-related width, and nipple-related color; generating, by the one or more processors, a 3D model of the user's nipple based on the plurality of geometric features; and determining, by the one or more processors, based on the 3D model of the user's nipple, a baby bottle nipple profile corresponding to the user's nipple to allow 3D printing of a custom baby bottle nipple; wherein the custom baby bottle nipple is a 3D replication of the user's nipple.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the present disclosure.

FIG. 1 is a block diagram illustrating an operating computer architecture for predictive visualization of a medical procedure of a user, according to one or more embodiments of the present disclosure.

FIG. 2 is a flow diagram illustrating a method for scanning and replicating the shape of a mother's nipple, according to one or more embodiments of the present disclosure.

FIG. 3 is a schematic diagram depicting an exemplary path for scanning a nipple of a user, according to one or more embodiments of the present disclosure.

FIG. 4 is a schematic diagram of a plurality of frames of a scan image, according to one or more embodiments of the present disclosure.

FIG. 5 is an exemplary output scan image with a bounding box, according to one or more embodiments of the present disclosure.

FIG. 6 is a schematic diagram of a nipple depicting a base diameter and a teat diameter, according to one or more embodiments of the present disclosure.

FIG. 7A is an isolated nipple point cloud, according to one or more embodiments of the present disclosure.

FIG. 7B is a nipple point cloud oriented using point cloud normal, according to one or more embodiments of the present disclosure.

FIG. 7C is a nipple point cloud with point cloud vectors on the surface that are filtered to create a gap in the scan that isolates the teat from the breast, according to one or more embodiments of the present disclosure.

FIG. 7D is a nipple point cloud with predetermined contours combined to rebuild the user's nipple without any gaps or holes, according to one or more embodiments of the present disclosure.

FIG. 7E is a marching cube watertight mesh, according to one or more embodiments of the present disclosure.

FIG. 8 is a flow diagram illustrating an algorithm method, according to one or more embodiments of the present disclosure.

FIG. 9 is a three-dimensional point cloud after a first genetic process of an algorithm, according to one or more embodiments of the present disclosure.

FIG. 10 is a three-dimensional point cloud after a second genetic process of an algorithm, according to one or more embodiments of the present disclosure.

FIG. 11 is a three-dimensional point cloud after a third genetic process of an algorithm, according to one or more embodiments of the present disclosure.

FIG. 12 is a three-dimensional point cloud after the algorithm filters out the normal, according to one or more embodiments of the present disclosure.

FIG. 13 is a three-dimensional point cloud after the algorithm filters out the normal, according to one or more embodiments of the present disclosure.

FIG. 14 is a set of graphs depicting a roughness algorithm output, according to one or more embodiments of the present disclosure.

FIG. 15 is a fine scale analysis and a rough scale analysis, according to one or more embodiments of the present disclosure.

FIG. 16 is smooth intensity map and a rough intensity map, according to one or more embodiments of the present disclosure.

FIG. 17 is a custom displacement map that estimates the color across the user's nipple, according to one or more embodiments of the present disclosure.

FIG. 18 is a diagram showing breast, teat, base and apex measurements for breast scanning, according to one or more embodiments of the present disclosure.

FIG. 19 illustrates invalid scans, according to one or more embodiments of the present disclosure.

FIG. 20A-20D illustrate rejected scans, according to one or more embodiments of the present disclosure.

FIG. 21A is a three-dimensional point cloud showing a scanned nipple with subtle slope, according to one or more embodiments of the present disclosure.

FIG. 21B is a three-dimensional point cloud showing scan sensitivity for a scanned nipple, according to one or more embodiments of the present disclosure.

FIG. 21C is a three-dimensional point cloud showing a poorly scanned nipple, according to one or more embodiments of the present disclosure.

FIG. 22A is a three-dimensional point cloud of a scanned nipple with accurately described shape, according to one or more embodiments of the present disclosure.

FIG. 22B is a three-dimensional point cloud showing inaccurate base width, according to one or more embodiments of the present disclosure.

FIG. 23A is a three-dimensional point cloud showing a scan rejection due to even distribution of noise, according to one or more embodiments of the present disclosure.

FIG. 23B is a three-dimensional point cloud showing a sparse point cloud resulting from an acceptable scan, according to one or more embodiments of the present disclosure.

FIG. 24 is a flow chart that details the scanning and point cloud data processing method, according to one or more embodiments of the present disclosure.

FIG. 25A is a diagram that shows the extraction of four dimensions to define nipple shape by using four measurements estimated by reading three contours, according to one or more embodiments of the present disclosure.

FIG. 25B is a diagram that shows the gathering of profile data at one or more (e.g., four) points to extract one or more (e.g., 2-4) major dimensions, and the approximation of nipple shape through the use of four extracted contours, according to one or more embodiments of the present disclosure.

FIG. 26A is a diagram showing a pitch scan strategy for scanning a nipple, according to one or more embodiments of the present disclosure.

FIG. 26B is a diagram showing a yaw scan strategy for scanning a nipple, according to one or more embodiments of the present disclosure.

FIG. 27 is a flow diagram illustrating a method for isolating and processing 3D point cloud data associated with a breast scan, according to one or more embodiments of the present disclosure.

FIG. 28A is a diagram showing the scanning strategy, or the process in which a user will be asked to gather a point cloud, according to one or more embodiments of the present disclosure.

FIG. 28B is a three-dimensional point cloud showing the filtering, or removal of certain parts of a scan based on certain features, such as the vertex angle, of the scan, according to one or more embodiments of the present disclosure.

FIG. 29 is a three-dimensional model showing scan noise that may result in an increase in the apparent top diameter of the nipple's peak for a nipple scan, according to one or more embodiments of the present disclosure.

FIG. 30A is a three-dimensional point cloud showing the raw input from object detection and the breast scan without preprocessing, where the input comes in at an arbitrary direction with the area of interest marked in a bounding box, according to one or more embodiments of the present disclosure.

FIG. 30B is a three-dimensional point cloud showing the preprocessed orientation from the input, where the scanned area has been oriented in the correct direction according to one or more embodiments of the present disclosure.

FIG. 31 is a selection of three-dimensional point clouds showing that filtering of the point cloud in steps allows for a large pool of nipple peaks to be analyzed, according to one or more embodiments of the present disclosure.

FIG. 32A is a three-dimensional point cloud showing that additional contours are placed on the surrounding breast to give a more accurate estimation of the nipple's curvature, according to one or more embodiments of the present disclosure.

FIG. 32B is a three-dimensional point cloud showing the lining up of the apex and nipple radius, according to one or more embodiments of the present disclosure.

FIG. 33 is a diagram showing the adjustment of the original base design in response to algorithm output, according to one or more embodiments of the present disclosure.

FIG. 34 is a flow diagram illustrating a method for scanning and replicating the shape of a mother's nipple using either tailored or custom processes, according to one or more embodiments of the present disclosure.

FIG. 35A is a three-dimensional point cloud showing the point cloud output of the scan, according to one or more embodiments of the present disclosure.

FIG. 35B is a three-dimensional mesh produced using the Marching Cubes algorithm, according to one or more embodiments of the present disclosure.

FIG. 35C is a three-dimensional contour-based sweep, according to one or more embodiments of the present disclosure.

FIG. 35D is a three-dimensional model of a patient's nipple constructed using the replication algorithm for remeshing a point cloud, according to one or more embodiments of the present disclosure.

FIG. 36A and FIG. 36B is a diagram that shows the extraction of dimensions.

FIG. 37 is a flow diagram illustrating a method for scanning and replicating the shape of a mother's nipple using either tailored or custom processes, according to one or more embodiments of the present disclosure.

FIG. 38A, FIG. 38B, and FIG. 38C show scanning techniques. The scan optimization module 120 may receive images from front scan and identify blind spots and/or nipple base inaccuracies. The scan optimization module 120 may receive images from pitch scan and identify large lateral and proximal blind spots. The scan optimization module 120 may receive images from yaw scan and identify under-breast blind spots and/or proximal nipple blind spots.

FIG. 39 is a three-dimensional model of a mesh constructed form a scan using the Marching Cubes algorithm to translate point cloud data into a digestible mesh with blind spots, according to one or more embodiments of the present disclosure.

FIG. 40A is a three-dimensional model showing a segmented section of a scanned breast and nipple that has been oriented upwards according to one or more embodiments of the present disclosure.

FIG. 40B is a three-dimensional model showing that the base and top of the nipple have been isolated through removal of sides angled far away from the central axis, according to one or more embodiments of the present disclosure.

FIG. 41A is a three-dimensional model showing that isolated contours are placed on the surrounding breast to give a more accurate estimation of the nipple's curvature, according to one or more embodiments of the present disclosure.

FIG. 41B is a three-dimensional model showing that isolated contours are placed on the surrounding breast to give a more accurate estimation of the nipple's curvature, according to one or more embodiments of the present disclosure.

FIG. 42A is a three-dimensional model showing that contours are placed on the surrounding breast to give a more accurate estimation of the nipple's curvature, according to one or more embodiments of the present disclosure.

FIG. 42B is a diagram illustrating the extraction of contours to approximate nipple shape, according to one or more embodiments of the present disclosure.

FIG. 43 shows region of interest of breast.

FIG. 44 is a flow diagram illustrating the object detection and quantitative assessment of scan quality, according to one or more embodiments of the present disclosure.

FIG. 45 is a diagram illustrating the verification process, according to one or more embodiments of the present disclosure.

FIG. 46A is a graph showing indistinct clustering of data, according to one or more embodiments of the present disclosure.

FIG. 46B is a series of graphs showing distinct clustering of data, according to one or more embodiments of the present disclosure.

FIG. 46C is a graph showing the distributions of measured and algorithm average base widths, according to one or more embodiments of the present disclosure.

FIG. 47A is a diagram illustrating the extraction of contours to approximate nipple shape, according to one or more embodiments of the present disclosure.

FIG. 47B is a three-dimensional point cloud showing breast points defined at X=0 and y=0, according to one or more embodiments of the present disclosure.

FIG. 48 is a series of three-dimensional models showing tailored products, according to one or more embodiments of the present disclosure.

FIG. 49 is a series of swatches representing common nipple shades, according to one or more embodiments of the present disclosure.

FIG. 50A-50C include a series of images illustrating a user interface for a scanning application, according to one or more embodiments of the present disclosure.

FIG. 51 is a series of three-dimensional models showing nipple shape variation, according to one or more embodiments of the present disclosure.

FIG. 52 shows a flow chart.

FIGS. 53A and 53B shows rebuilding geometry was through outlining the lateral profile of the nipple and rotating it around the nipple's central axis.

FIG. 54 shows bottle integration.

FIG. 55 shows a flow chart.

FIG. 56 shows planar interpolation.

FIG. 57 shows noise.

FIG. 58A-58D shows simplification.

FIG. 59 shows a flow chart.

FIG. 60 shows a depth image.

FIG. 61 shows received raw point clouds.

FIGS. 62A and 62B show surface normal.

FIG. 63 shows data processing flow.

FIG. 64 shows autoencoder.

FIG. 65 shows TSNE.

FIGS. 66A and 66B shows nearest neighbor.

### DETAILED DESCRIPTION

The present invention may be further explained with reference to the included drawings, wherein like structures are referred to by like numerals throughout the several views. The drawings shown are not necessarily to scale, with emphasis instead generally being placed upon illustrating the principles of the present invention. Therefore, specific structural and functional details disclosed herein are not to be interpreted as limiting, but merely as a representative basis for teaching one skilled in the art to variously employ the present invention.

Among those benefits and improvements that have been disclosed, other objects and advantages of this invention may become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the present invention is intended to be illustrative, and not restrictive.

Nipple confusion is a common syndrome in which newborn babies have trouble latching to their mother's breast after being fed with a baby bottle. In some embodiments, nipple confusion can be addressed by selecting baby bottle nozzle and mechanisms to resemble those of the mother's nipple. Described herein are methods for scanning and replicating the shape of a mother's nipple such that the replicated nipple may be integrated with a baby bottle. In some embodiments, an automated mass is created using a customization technique for replicating the shape of a mother's nipple and integrating the replicated nipple with a larger baby bottle. Also described herein are platforms for providing enhanced scans of the mother's breast. In some embodiments, artificial intelligence (AI) is used to optimize the scans provided by the platform. In some embodiments, the methods described herein use a combination of 3D scanning, AI object detection, a novel mesh post-processing and a novel texturizing procedure to create custom nipples for users.

If Texture Among the Shapes/Nipples is Not the Same, then Include Texture from First Provisional 195870-012300 as Separate Embodiment when Writing Non-Prov

In some embodiments, as described above, AI is used to produce a scan image of the mother's breast using object detection. In some embodiments, the AI includes at least one machine learning model, such as a neural network. In some embodiments, the neural network is a convolutional neural network. In some embodiments, the neural network is a deep learning network, a generative adversarial network, a recurrent neural network, a fully connected network, or combinations thereof.

In some embodiments, to gather easy and adequate scans for nipple replication, the present disclosure provides a method of scanning for users to use in their homes using a structural light sensor often found in the front-facing camera in modern mobile phones. In some embodiments, the scanning method utilizes a mobile phone's built-in facial recognition system to take multiple scans of a mother's breast by stitching individual scans of the mother's breast, taken by the mobile phone, to form a sparse 3D point cloud. In some embodiments, the scanning method also includes recognizing the mother's breast in 3D space and detecting a frontal image of the mother's nipple to use for color matching. In some embodiments, the scanning method includes extracting one or more measurements and contours of the mother's nipple scan to direct the mother to the most appropriate nipple product for her unique body.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention. Further, when a particular feature, structure, or characteristic is described in connection with an implementation, it is submitted that it is within the knowledge of one skilled in the art to effect such feature, structure, or characteristic in connection with other implementations whether or not explicitly described herein.

In addition, as used herein, the term “or” is an inclusive “or” operator, and is equivalent to the term “and/or,” unless the context clearly dictates otherwise. The term “based on” is not exclusive and allows for being based on additional factors not described unless the context clearly dictates otherwise. In addition, throughout the specification, the meaning of “a,” “an,” and “the” include plural references. The meaning of “in” includes “in” and “on.”

It is understood that at least one aspect/functionality of various embodiments described herein may be performed in real-time and/or dynamically. As used herein, the term “real-time” is directed to an event/action that may occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation may be used in guiding the physical process.

As used herein, the term “dynamically” means that events and/or actions may be triggered and/or occur without any human intervention. In some embodiments, events and/or actions in accordance with the present invention may be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

In some embodiments, the inventive specially programmed computing systems with associated devices are configured to operate in the distributed network environment, communicating over a suitable data communication network (e.g., the Internet, etc.) and utilizing at least one suitable data communication protocol (e.g., IPX/SPX, X.25, AX.25, AppleTalk™, TCP/IP (e.g., HTTP), etc.). Of note, the embodiments described herein may, of course, be implemented using any appropriate hardware and/or computing software languages. In this regard, those of ordinary skill in the art are well versed in the type of computer hardware that may be used, the type of computer programming techniques that may be used (e.g., object-oriented programming), and the type of computer programming languages that may be used (e.g., C++, Objective-C, Swift, Java, JavaScript). The aforementioned examples are, of course, illustrative and not restrictive.

As used herein, the terms “image(s)” and “image data” are used interchangeably to identify data representative of visual content which includes, but not limited to, images encoded in various computer formats (e.g., “.jpg”, “.bmp,” etc.), streaming video based on various protocols (e.g., Real-time Streaming Protocol (RTSP), Real-time Transport Protocol (RTP), Real-time Transport Control Protocol (RTCP), etc.), recorded/generated non-streaming video of various formats (e.g., “.mov,” “.mpg,” “.wmv,” “.avi,” “.flv,” ect.), and real-time visual imagery acquired through a camera application on a mobile device.

As used herein, term “server” should be understood to refer to a service point which provides processing, database, and communication facilities. By way of example, and not limitation, the term “server” may refer to a single, physical processor with associated communications and data storage and database facilities, or it may refer to a networked or clustered complex of processors and associated network and storage devices, as well as operating software and one or more database systems and application software that support the services provided by the server. Cloud servers are examples.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

In another form, a non-transitory article, such as a non-transitory computer readable medium, may be used with any of the examples mentioned above or other examples except that it does not include a transitory signal per se. It does include those elements other than a signal per se that may hold data temporarily in a “transitory” fashion such as RAM and so forth.

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the one or more processors, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

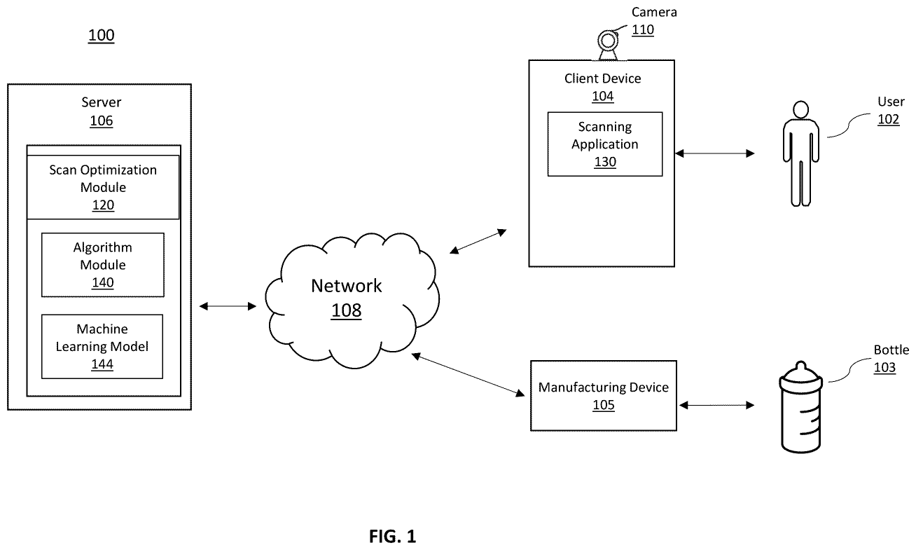

FIGS. 1 through 17 illustrate exemplary systems and methods for scanning and replicating the shape of a mother's nipple such that the replicated nipple may be integrated with a baby bottle. The following embodiments can provide technical solutions and technical improvements that overcome technical problems, drawbacks and/or deficiencies in at least one technical field involving efficiency and accuracy of computing systems utilized in assisting the formation of baby bottle nipples that accurately mimic the nipple of a breastfeeding mother, described herein. For example, at least one technical difficulty is the efficiency of computing system in extracting from images, e.g., pixels, useful visual data that may be utilized to replicate a mother's nipple. As explained in more detail below, the present disclosure provides a technically advantageous computer architecture that improves scan images of a mother's breast, based at least in part on scan image data of other users (i.e., other breastfeeding mothers), to create a more realistic and lifelike baby bottle nipple that mimics the nipple of the breastfeeding mother, thereby reducing nipple confusion by the baby. In some embodiments, the systems and methods are technologically improved by being programmed with machine-learning modeling to create a 3D scan image. Some embodiments leverage the wide-spread use of mobile personal communication devices (e.g., smart phones with integrated cameras) to facilitate the inputting of user-generated data to enhance the 3D scan image.

FIG. 1 illustrates a block diagram illustration of an exemplary nipple scanning system 100 consistent with some embodiments of the present disclosure. The components and arrangements shown in FIG. 1 are not intended to limit the disclosed embodiments as the components used to implement the disclosed processes and features may vary. In accordance with the disclosed embodiments, the nipple scanning system 100 may include a server 106 in communication with a client device 104 of a user 102 and a manufacturing device 105 via a network 108.

Network 108 may be of any suitable type, including individual connections via the internet such as cellular or Wi-Fi networks. In some embodiments, network 108 may connect participating devices using direct connections such as radio-frequency identification (RFID), near-field communication (NFC), Bluetooth™, low-energy Bluetooth™ (BLE), Wi-Fi™, ZigBee™ ambient backscatter communications (ABC) protocols, USB, WAN or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

Server 106 may be associated with a medical practice or other type of practice or entity. For example, server 106 may manage user information. One of ordinary skill will recognize that server 106 may include one or more logically or physically distinct systems.

In some embodiments, the server 106 may include hardware components such as one or more processors (not shown), which may execute instructions that may reside in local memory and/or transmitted remotely. In some embodiments, the one or more processors may include any type of data processing capacity, such as a hardware logic circuit, for example, an application specific integrated circuit (ASIC) and a programmable logic, or such as a computing device, for example a microcomputer or microcontroller that includes a programmable microprocessor.

In some embodiments, the client device 104 may be associated with the user 102 who is a breastfeeding mother. In some embodiments, the manufacturing device 105 may be associated with an entity, such as a medical practice or medical products company. When the user 102 wishes to generate a baby bottle nipple, the server 106 may prompt the user 102 to input user information and a scan image via the client device 104.

In some embodiments, the client device 104 and/or the manufacturing device 105 may be a mobile computing device. The client device 104 and/or the manufacturing device 105, or mobile client devices, may generally include at least computer-readable non-transient medium, a processing component, an Input/Output (I/O) subsystem and wireless circuitry. These components may be coupled by one or more communication buses or signal lines. The client device 104 and/or the manufacturing device 105 may be any portable electronic devices, including a mobile phone, a handheld computer, a tablet computer, a laptop computer, a tablet device, a multifunction device, a portable gaming device, a vehicle display device, or the like, including a combination of two or more of these items. In some embodiments, the mobile client device 104 may be any appropriate device capable of taking still images or video with an equipped front camera. In some embodiments, the client device 104 and/or the manufacturing device 105 may be a desktop computer.

As shown in FIG. 1, in some embodiments, the client device 104 includes a user camera 110. In some embodiments, at least one user image may be captured by the user camera 110 and transmitted via network 108. In some embodiments, the at least one scan image capture may be performed by a scanning application 130 available to all users of the client device 104. In some embodiments, the at least one scan image capture may be performed by a camera application that comes with a mobile client device 104, and the resulting at least one scan image may be uploaded to the scanning application 130.

In some embodiments, wireless circuitry is used to send and receive information over a wireless link or network to one or more other devices' suitable circuitry such as an antenna system, an RF transceiver, one or more amplifiers, a tuner, one or more oscillators, a digital signal processor, a CODEC chipset, memory, etc. The wireless circuitry may use various protocols, e.g., as described herein.

It should be apparent that the architecture described is only one example of an architecture for the client device 104 and/or the manufacturing device 105, and that the client device 104 and/or the manufacturing device 105 may have more or fewer components than shown, or a different configuration of components. The various components described above may be implemented in hardware, software, or a combination of both hardware and software, including one or more signal processing and/or application specific integrated circuits.

In some embodiments, the client device 104 may include an application such as the scanning application 130 (or application software) which may include program code (or a set of instructions) that performs various operations (or methods, functions, processes, etc.), as further described herein. In some embodiments, the client device 104 may include the scan optimization module 120 and perform the functionalities described herein on the client device 104.

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In some embodiments, the scanning application 130 enables the user 102 to upload a scan image to the server 106. In some embodiments, the scanning application 130 may be an application provided by a medical entity or other entity. In one implementation, the scanning application 130 may be automatically installed onto the client device 104 after being downloaded. In addition, in some embodiments, the scanning application 130 or a component thereof may reside (at least partially) on a remote system (e.g., server 106) with the various components (e.g., front-end components of the scanning application 130) residing on the client device 104. As further described herein, the scanning application 130 and the server 106 may perform operations (or methods, functions, processes, etc.) that may require access to one or more peripherals and/or modules. In the example of FIG. 1, the server 106 includes a scan optimization module 120 that may include an algorithm module 140 and a machine learning engine 144, as will be described in further detail below. In some embodiments, the scan optimization module 120 and its components may be included on the client device 104. For example, the scan optimization module 120 may be part of the scanning application 130. By having the scanning application 130 and the scan optimization module 120 on the client device 104, the scanning and analysis of the scans may be performed on the same device, which may result in faster analysis and avoid transmissions of scans via the network 108. For example, the client device 104 may perform the scanning and the analysis to avoid transmitting intimate photos of the exposed nipple.

In some embodiments, the scan image 112 may be processed by the scan optimization module 120, which is specifically programmed in accordance with the principles of the present invention with one or more specialized inventive computer algorithms. Further, in some embodiments, the scan optimization module 120 may be in operational communication (e.g., wireless/wired communication) with the server 106 which may be configured to support one or more functionalities of the scan optimization module 120.

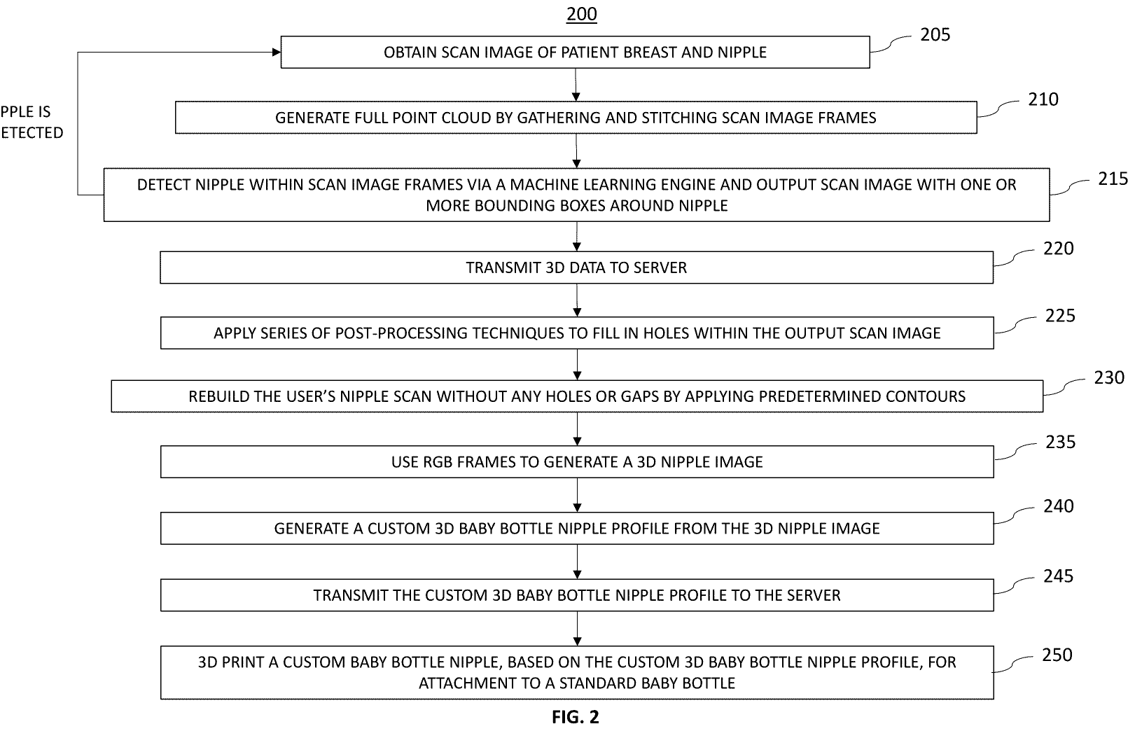

FIG. 2 illustrates a flow diagram of an exemplary method 200 of creating a 3D nipple from a scan image, according to some embodiments of the present disclosure.

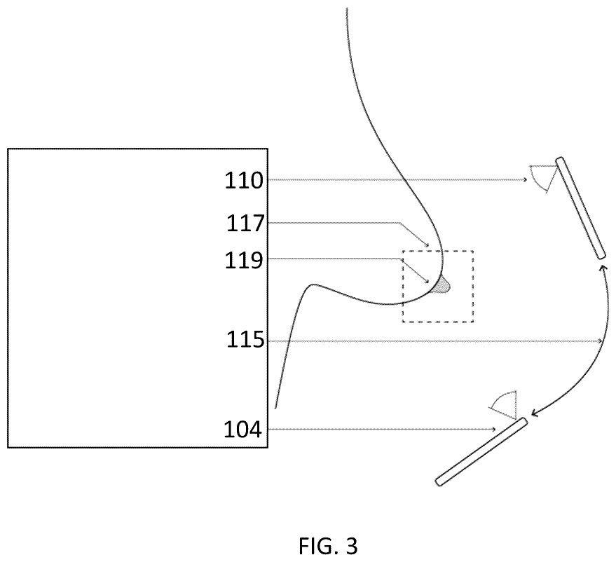

At step 205, once the user 102 is ready to scan her breast, the user 102 places the client device 104 approximately 1 to 2 feet underneath the user's breast 117 with a front camera 110 of the client device 104 framing the nipple 119 she wants to replicate. When ready, she presses record and gradually moves the client device 104 upwards from below her breast to slightly above the nipple, keeping the nipple approximately centered in frame, as depicted in FIG. 3. At step 205, the user 102 may also enter user information.

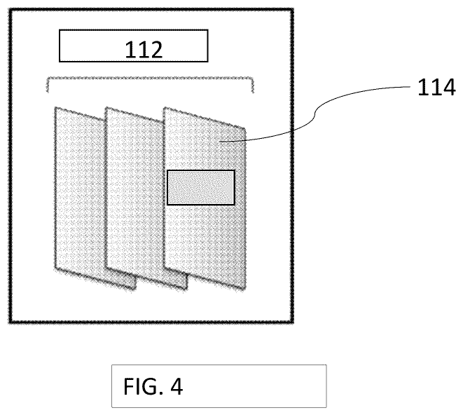

At step 210, in some embodiments, the scanning application 130 gathers and creates a full point cloud. For example, in some embodiments, the scan image 112 may be a video stream including a plurality of frames 114. As shown in FIG. 4, an exemplary video stream captured by the user camera 110 (e.g., a camera of a mobile phone) may be divided into frames 114. In some embodiments, each frame 114 may contain an image data with any known color model, including but not limited to: YCrCb, RGB, LAB, etc. In some embodiments, the scanning application 130 creates an RGB image sequence. In some embodiments, the scanning application 130 takes each frame 114 of the scan image 112 and stitches the frames 114 together to create the point cloud. In some embodiments, the scan image 112 (e.g., input video stream) may include any appropriate type of source for video contents. In some embodiments, the contents from the scan image 112 (e.g., the scanning video of FIG. 4) may include both video data and metadata. In some embodiments, the scan image 112 is a scan of the user's breast, captured by the front camera of the client device 104.

At 215 the scan optimization module 120 may recognize the nipple complex in the scan image 112. In some embodiments, the scan optimization module 120 may be implemented as an application (or set of instructions) or software/hardware combination configured to perform operations (or methods, functions, processes, etc.) for receiving and processing image data inputs (e.g., without limitation, image(s), video(s), etc.), via the network 108, from the client device 104. The scan optimization module 120 may receive the scan image 112 from the user 102 and employ a machine learning engine 144 to identify the user's nipple within the scan image 112. In some embodiments the machine learning engine 144 may include, e.g., software, hardware and/or a combination thereof. For example, in some embodiments, the machine learning engine 144 may include one or more processors and a memory, the memory having instructions stored thereon that cause the one or more processors to generate, without limitation, at least one 3D image.

In some embodiments, the machine learning engine 144 may be configured to utilize a machine learning technique. In some embodiment, the machine learning engine 144 may include one or more of a neural network, such as a feedforward neural network, radial basis function network, an image classifier, recurrent neural network, convolutional network, generative adversarial network, a fully connected neural network, or some combination thereof, for example. In some embodiments, the machine learning engine 144 may be composed of a single level of linear or non-linear operations or may include multiple levels of non-linear operations. For example, the machine learning engine 144 may include numerous layers and/or hidden layers that perform calculations (e.g., dot products) using various neurons.

In some embodiments and, optionally, in combination of any embodiment described above or below, an exemplary implementation of Neural Network may be executed as follows:
i) Define Neural Network architecture/model,
ii) Transfer the input data to the exemplary neural network model,
iii) Train the exemplary model incrementally,
iv) determine the accuracy for a specific number of timesteps,
v) apply the exemplary trained model to process the newly-received input data,
vi) optionally and in parallel, continue to train the exemplary trained model with a predetermined periodicity.

In some embodiments, the scan optimization module 120 may employ object recognition techniques to identify a nipple within a scan image 112. For example, in some embodiments, the scan optimization module 120 may employ an object detection model. In some embodiments, the object detection model may employ the machine learning engine 144 to recognize a nipple in the scan image 112. In some embodiments, the machine learning engine 144 is a convolutional neural network that performs a convolution operation to recognize objects in images. In some embodiments, a deep convolutional neural network (CNN) may be run to retrieve a feature vector, known as the encoder part. In some embodiments, scan image data may be connected with the feature vector and nonlinear convolutional layers are run to identify an object in a scan image.

In some embodiments the object detection model of the present disclosure includes a base architecture or series of “layers” it uses to process scan image data and return information about what is in the scan image 112. In some embodiments, the object detection model is trained on a unique dataset to recognize information in an image. In some embodiments, the dataset is gathered from multiple users taking images of their breasts, mostly along a specific path 115, as depicted in FIG. 3, moving from below the breast to just above the nipple. In some embodiments, the machine learning engine 144 of the object detection model is trained on a set of scan images of previous users used in a wide variety of applications that contain a nipple to detect the nipple location in a two-dimensional image. In some embodiments, the machine learning engine 144 is trained on hundreds of training scan images. In other embodiments, the machine learning engine 144 is trained on thousands of training scan images. In other embodiments, the machine learning engine 144 is trained on tens of thousands of training scan images. In other embodiments, the machine learning engine 144 is trained on hundreds of thousands of training scan images.

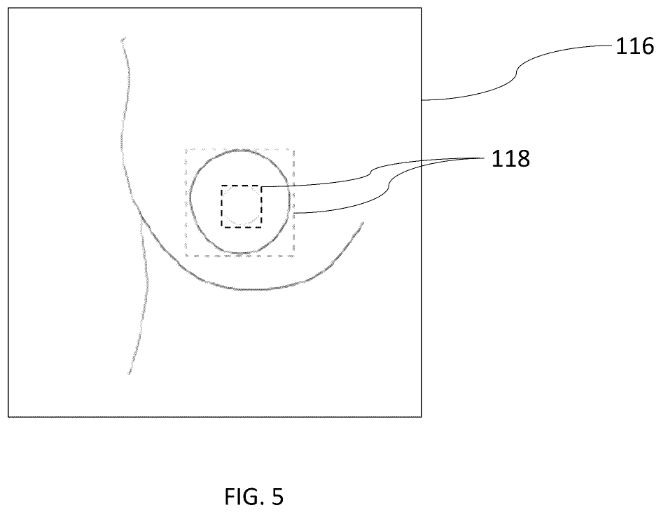

In some embodiments, the machine learning engine 144 can identify at least one frame of the nipple for color, help ensure that the user's scan image 112 is correctly seeing the nipple and isolate the nipple part of the point cloud for the scan optimization module 120. In some embodiments, the machine learning engine 144 outputs an output scan image 116 with one or more bounding boxes 118 (e.g., defined by a point, width, and height), and a class label for each bounding box 118, as depicted in FIG. 5. In some embodiments, the trained machine learning engine 144 can detect at least one group of classes. In some embodiments, the groups of classes include a nipple complex including the areola and the teat; only a teat; and/or a frontal view of the entire nipple (e.g., for collecting information on color). In some embodiments, the trained machine learning engine 144 can detect a nipple complex including the areola and the teat. In some embodiments, the trained machine learning engine 144 can detect only a teat. In some embodiments, the trained machine learning engine 144 can detect a frontal view of the entire nipple.

At step 215, in some embodiments, if the machine learning engine 144 detects during scanning that too many of the scan image frames 114 do not contain a nipple, the application provides an error message to the user and asks the user to re-scan her nipple, starting the method again at step 210.

At step 220, the scanning application 130 may transmit the output scan image 116 with the 3D bounding box 118 around the nipple, the colored .ply point cloud, and the series of color (RGB) images to the server 106 for a novel post-processing and texturizing procedure for nipple geometries. In some embodiments, the scanning application 130 may transmit the 3D bounding box 118 around the nipple and the point cloud but not the RGB images.

Ask if They are Cropping the Bounding Box Differently

While the process for collecting the output scan image is designed to be easy, the resulting output scan image may contain holes and noise due to the lower resolution of the scanner and the natural fluctuations of the scan image. As a result, in step 225, a series of post-processing techniques are required to fill in the holes within the output scan image 116, while crucially collecting important dimensional information about the nipple itself. In some embodiments, if the post-processing procedure shows an error message, the user is given information as to why an error occurred and is asked to re-scan her nipple.

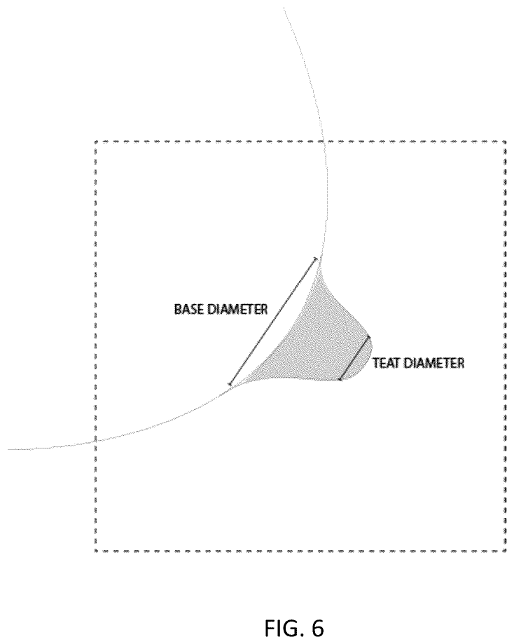

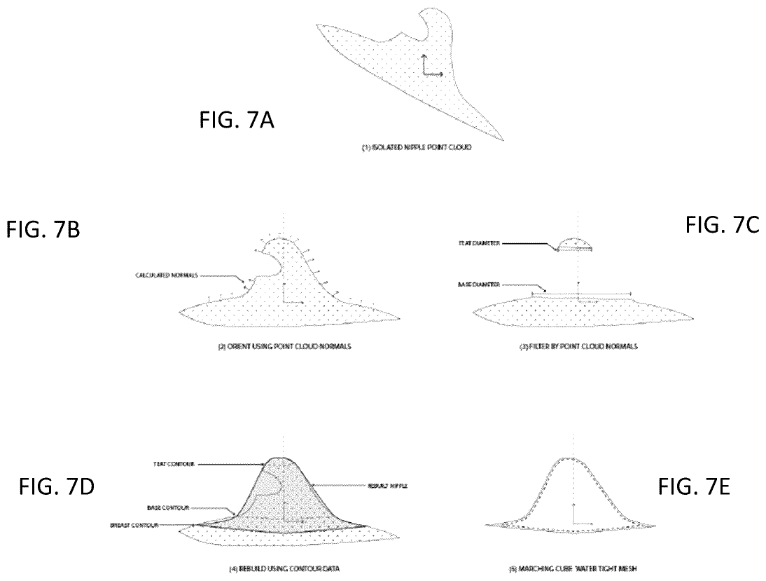

Nipple may contain two important dimensions as it pertains to nipple confusion: base diameter and teat diameter. The base diameter is defined as the diameter around which the nipple meets the breast, and the teat diameter is defined as the diameter around which the nipple starts to curve downward or its inflection point, as depicted in FIG. 6. In some embodiments, the post-processing techniques described below replicate nipple geometry and extract base and teat diameter information for both tailored and customized baby bottle nipples. FIGS. 7A-7E can depict each step of the post-processing method applied to an isolated nipple point cloud, depicted in FIG. 7A, according to embodiments of the present disclosure.

At 225, the scan optimization module 120 may perform various tasks, as will be described in further detail below. In some embodiments, the scan optimization module 120 may automatically orient the isolated nipple point cloud upwards along the z-axis, as depicted in FIG. 7B. In some embodiments, the algorithm module 140 can calculate the surface vectors at each point. In some embodiments, the algorithm module 140 can filter out the surface vectors that are too far from the z-axis to create a gap in the scan that isolates the teat from the breast, as depicted in FIG. 7C. The scan optimization module 120, in some embodiments, may include any or all the following steps, described below with reference to FIGS. 7A-C and 9-11, and involves collecting information on nipple height; teat width; nipple base width; large scale textural roughness; small scale textural roughness; breast color; and/or nipple color.

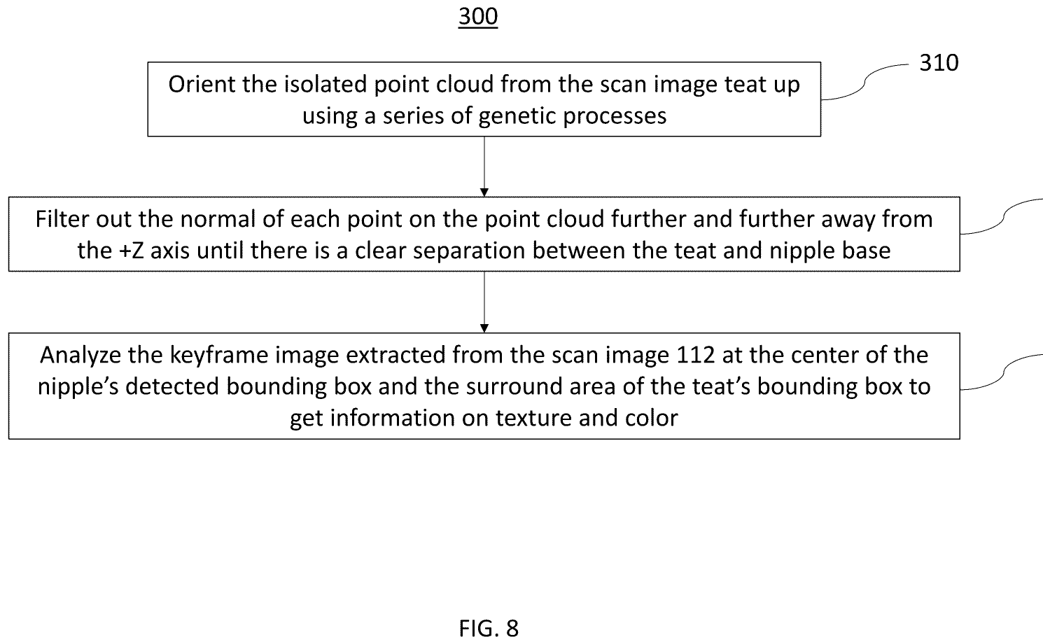

FIG. 8 is a flow chart depicting the method 300. In some embodiments, the algorithm module 140 may include one or more genetic algorithms or processes. In some embodiments, at 310, the algorithm module 140 may orient the isolated point cloud from the scan image 112 teat up (+z axis) using a series of algorithmic processes (e.g., genetic processes).

### Orient Based on the Depth Image

In some embodiments, the series of algorithmic processes may minimize the cross-sectional area of the point cloud at the top, minimize the height of the overall scan and minimize the average normal at the heights part of the scan. In some embodiments, the series of processes may randomly mutate and/or modify parameters through multiple iterations until local minima are achieved. In some embodiments, these processes may be different than machine learning in that they do not require training For example, these processes may work independently of the machine learning engine 144. In some embodiments, the processes include any or all the three genetic processes as described below.

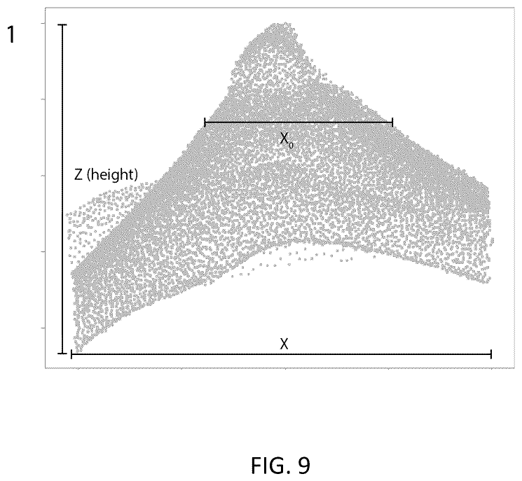

In some embodiments, the first genetic process of the algorithm module 140 may minimize the overall height of the scan by rotating the point cloud in the x and y axis and the ratio of the x and y dimensions (X₀ and Y₀) at the top quarter of the scan to the x and y dimension of the scan as a whole, as depicted in FIG. 9.

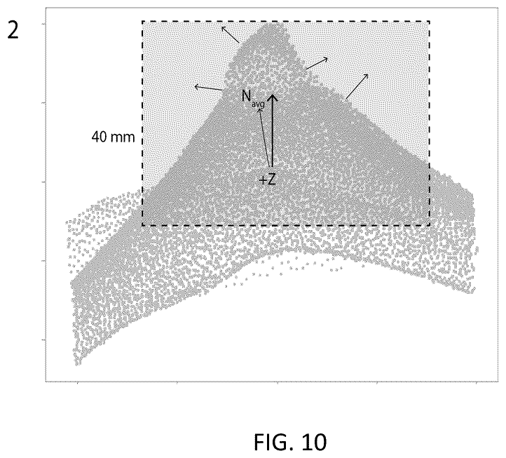

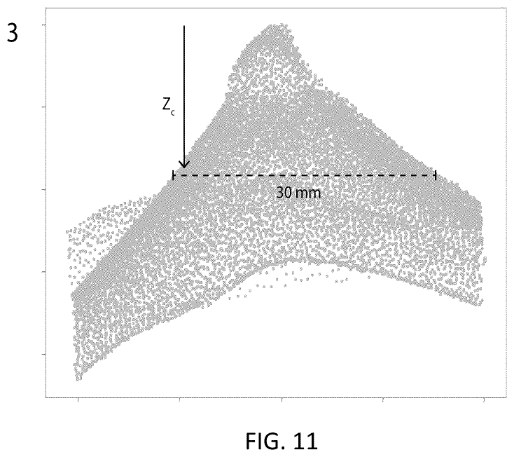

In some embodiments, the second genetic process of the algorithm module 140 may set the average normal at the top portion of the scan as close to the +Z axis as possible, as depicted in FIG. 10.

In some embodiments, the third genetic process of the algorithm module 140 may maximize a height at which the teat exceeds a predetermined cross-sectional diameter (Z_{c}), as depicted in FIG. 11. In some embodiments, the predetermined cross-sectional diameter is 30 mm In some embodiments, the predetermined cross-sectional diameter is 25 mm to 35 mm; or 27 mm to 35 mm; or 29 mm to 35 mm; or 31 mm to 35 mm; or 33 mm to 35 mm; or 25 mm to 33 mm; or 25 mm to 31 mm; or 25 mm to 29 mm; or 25 mm to 27 mm; or 26 mm to 30 mm; or 29 mm to 30 mm; or 30 mm to 31 mm. In some embodiments, each generation in the genetic process may score itself based on rotations along the x and y axes. In some embodiments, once the smallest possible score is achieved, the algorithm module 140 may move on to the next genetic process until the scan is properly oriented. In some embodiments, if the algorithm module 140 identifies too many holes around the edge of the teat, the algorithm module 140 may transmit a request to the client device 104 to redo the scan image. For example, the transmission may include a request that the user moves slowly from underneath the breast to above the nipple.

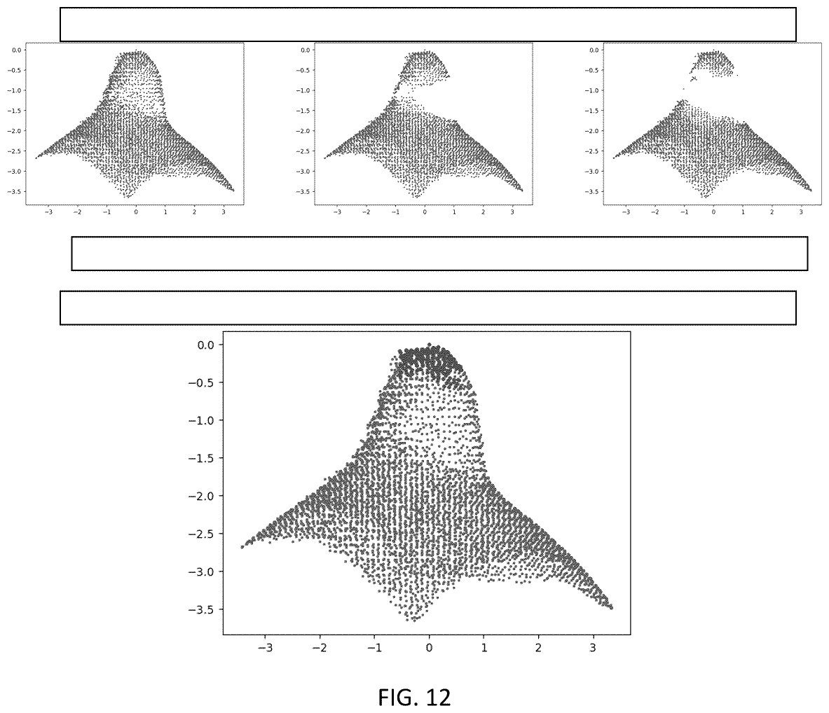

At 320, the algorithm module 140 may use one or more genetic processes to filter out the normal of each point in the point cloud further and further away from the +Z axis, until there is a clear separation between the teat and the nipple base, as depicted in FIG. 11. In some embodiments, the normal of each point in the point cloud may be estimated based on the positions of the point's nearest neighbors. In some embodiments, the dot product of each normal is taken with the +Z axis ([0,0,1]). In some embodiments, the algorithm module 140 may measure the width at the bottom of the teat and the top of the nipple base to get the teat width and the nipple base width, respectively. In some embodiments, the algorithm module 140 may measure the distance between the +Z axis at the base and the +Z axis at the top of the nipple scan to get the nipple height, as depicted in FIG. 12. In some embodiments, if the algorithm module 140 is unable to separate the nipple base and the teat, the algorithm module 140 may indicate that the user should try to stimulate the nipple more. In some embodiments, if the algorithm module 140 sees that the top of the scan is above a quarter of the width of the bottom of the scan, the algorithm module 140 may provide an error and asks the user if she moved during the scan.

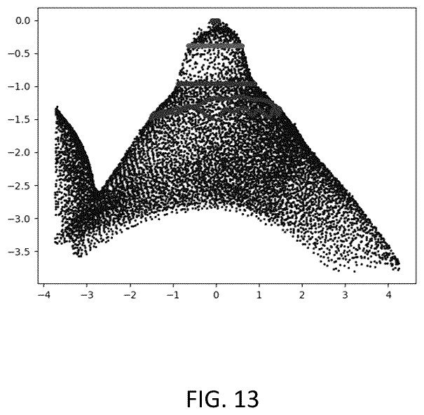

In some embodiments, at 330, the algorithm module 140 may analyze the at least one frame image extracted from the scan image 112 at the center of the nipple's detected bounding box and the surround area of the teat's bounding box to get information on size and color of the nipple and/or breast, as depicted in FIG. 13. In some embodiments, subsequent to the scanning application 130 returning images of the breast during scanning and a front frame image of the breast is identified, the trained machine learning engine 144 may identify the teat. In some embodiments, subsequent to the identification of the location of the teat in a 2D frame, the average color of the pixels around the teat area may be used as the color value for that user.

At step 230, once the location of the z height of teat and base diameters are found, predetermined contours may be combined to rebuild the user's nipple without any gaps or holes, as depicted in FIG. 7D. In some embodiments, scanning application 130 may extract one or more features and measurements from the scan images that are used to replicate the shape and size of the user's nipple. For example, in some embodiments, the predetermined contours may include: a predetermined contour along the breast, a predetermined contour at the base of the nipple, a predetermined contour at the teat and a predetermined contour around the nipple apex. Finally, in some embodiments, a marching cubes function may be used to create a solid watertight mesh, as depicted in FIGS. 7E.

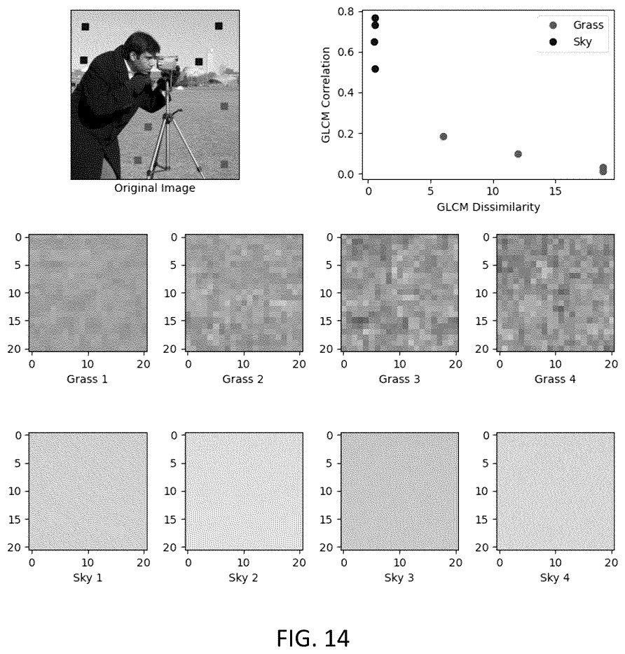

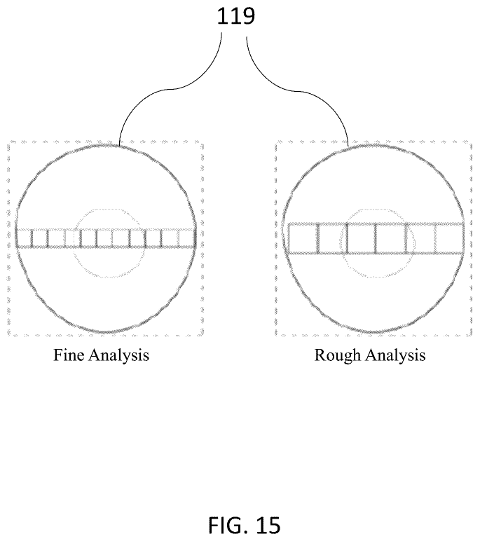

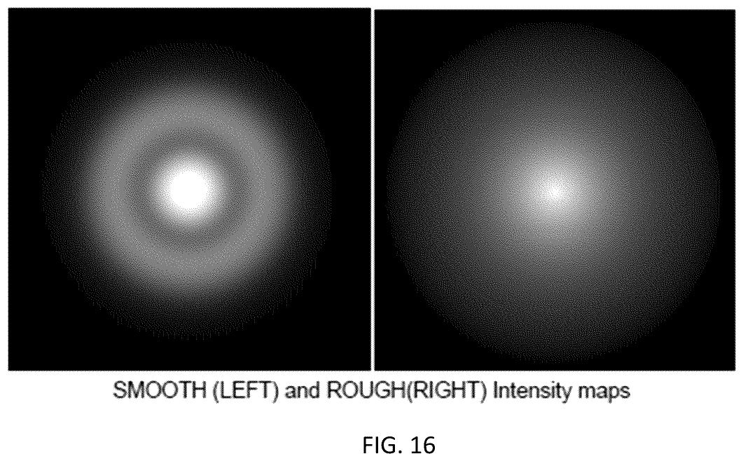

At step 235, the RGB frames provided by the scanning application 130 through the scanning process may be used to generate a model of the scanned nipple. In some embodiments, the object detection model may determine which frame 114 of the scan image 112 is aligned with the majority of the nipple and areola (frontal view). In some embodiments, the frame 114 may be isolated and used to measure “roughness” across the areola's and nipple's surfaces utilizing at least one gray scale image analysis tool. A sample output graphs of a roughness algorithm are depicted in FIG. 14. In some embodiments, at least one gray scale image analysis tool may be used at two different resolutions to determine large scale roughness values and fine scale roughness values. Examples of fine scale analysis and rough scale analysis are depicted in FIG. 15, according to embodiments of the present disclosure. In some embodiments these roughness values may be used to generate intensity maps, indicating where roughness/bumpiness is strongest, and where roughness/bumpiness is weakest, based on white and black values, respectively. FIG. 16 depicts an exemplary smooth intensity map and a rough intensity map, according to embodiments of the present disclosure. In some embodiments, the intensity maps may be identified based on a custom displacement map that estimates the skin color across the user's nipple, as depicted in FIG. 17.

At step 240, once the custom geometry with color identifiers are created, the nipple's 3D custom shape may be translated into a 3D baby bottle nipple profile that fits with a standard baby bottle. Specifically, the 3D baby bottle nipple, while having the shape of the user's nipple, may be size and formatted to fit to a standard commercial baby bottle. In some embodiments, the baby bottle nipple profile may include a base portion that may connect with a standard baby bottle via a baby bottle collar. In some embodiments, the baby bottle nipple profile may include a base portion that connects directly to a standard baby bottle.

At step 245, the custom 3D baby bottle nipple profile is sent to the server 106. The standard 3D nipple profile is accessible on the server 106 by the manufacturing device 105 for 3D printing of a bottle 103.

In some embodiments, the server 106 can store the user profile with the shape and color. In some embodiments, the client device 104 can store the user profile.

Once scan is matched to shape/color, the results sent to the user application. The two files can be saved (anonymously without identifying user information) in a server with the match result. For example, nipple shape and choice of color is the match result.

User profile can have two fields. Whenever user logs in to the app, app can retrieve (e.g., from server) their shape and color that user can change at any time.

Another example, scan can be used for logging and training—can log that a scan was assigned shape 2 and later manually validate the assignment to train the model. In some embodiments, nothing stored on the phone.

At step 250 a custom baby bottle nipple, based on the custom 3D baby bottle nipple profile, is 3D printed. In some embodiments, the custom baby bottle nipple may be integrated into a standard manufactured baby bottle part. In some embodiments, the result is a baby bottle capped with a 3D printed nipple designed to mimic the geometry and feel of the user's nipple.

In some embodiments, the entire process may sit in three different “locations.” The initial process of scanning the nipple and identifying its location in 3D space may exists on the user's phone—the first location. The phone application may produce a colored scan, eight points defining the nipple's location and a series of RGB images that are sent to a virtual machine for post-processing and texturing using the API—the second location. The API may send the resulting dimensions, solid watertight printable mesh .stl file, a single-color value, and/or any error information to a server for 3D printing and archiving—the third location. in some embodiments, third location is phone application to receive shape and color values—match result

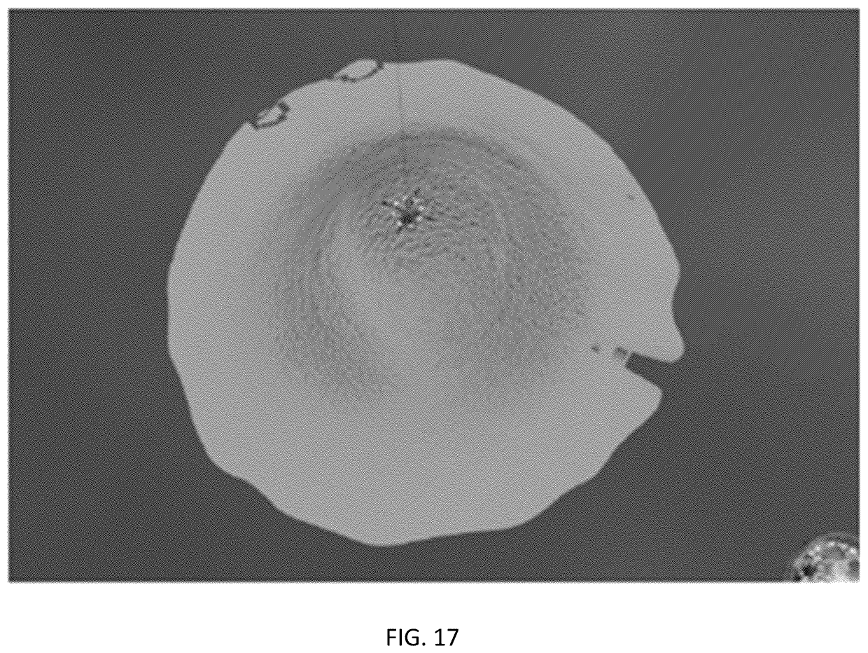

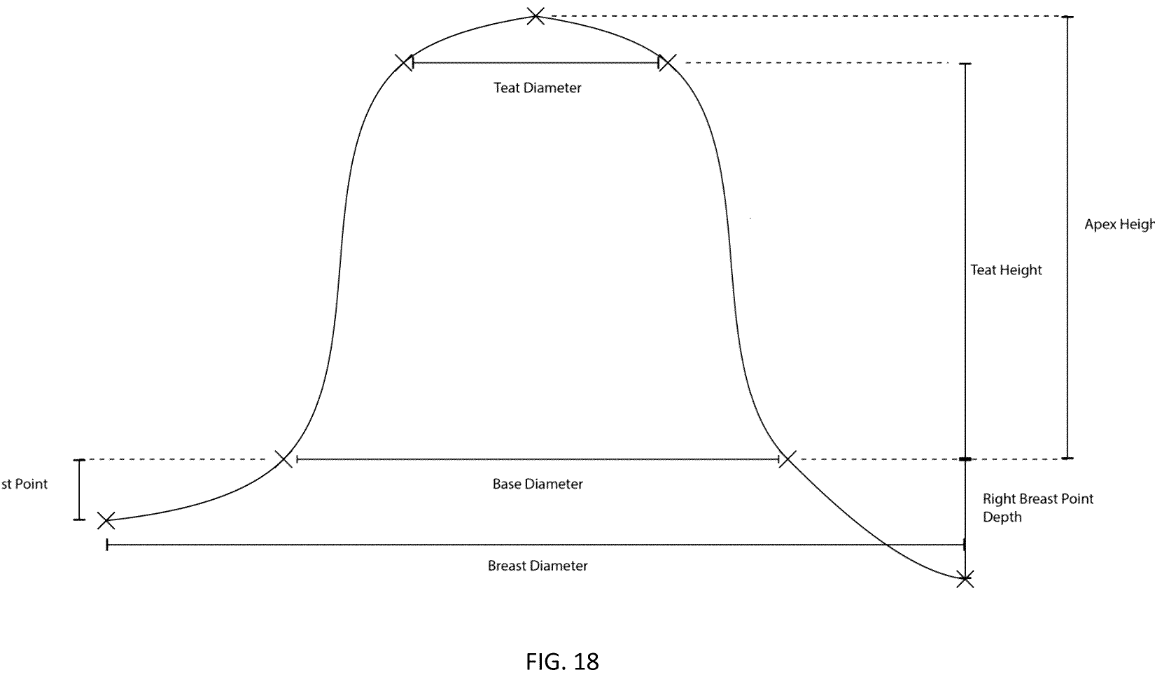

FIG. 18 is a diagram showing breast, teat, base and apex measurements for breast scanning, according to one or more embodiments of the present disclosure.

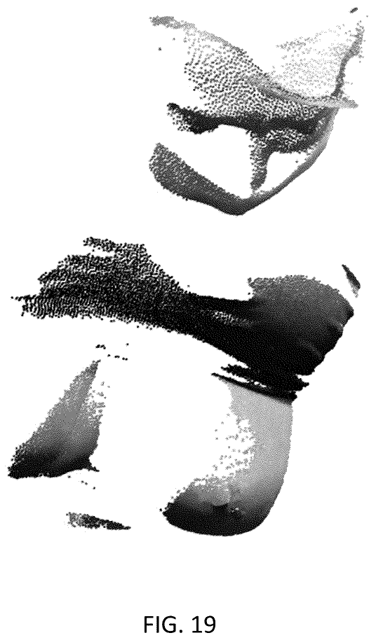

FIG. 19 show an invalid scan rate of approximately 10%. These errors may be reported almost immediately after the scan is complete (<1 seconds)

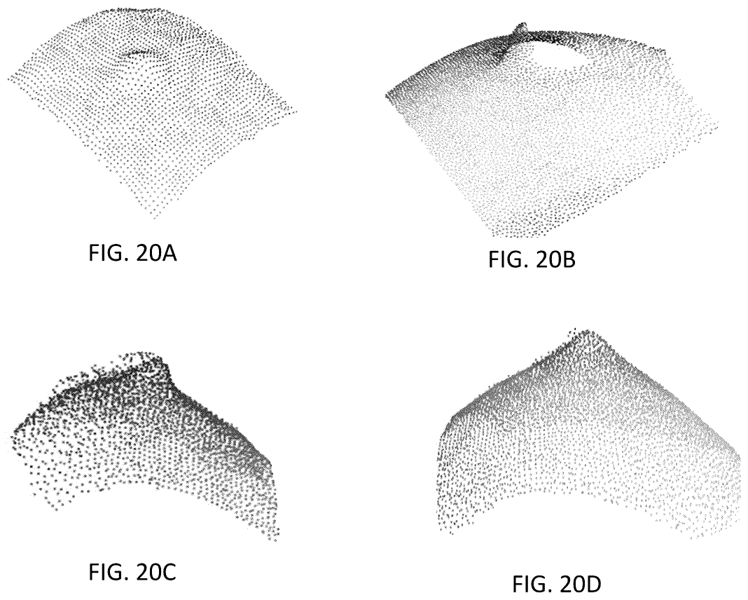

FIG. 20A-20D shows that, currently, approximately 1 out of every 2 scans run through the algorithm result in errors (<10 seconds).

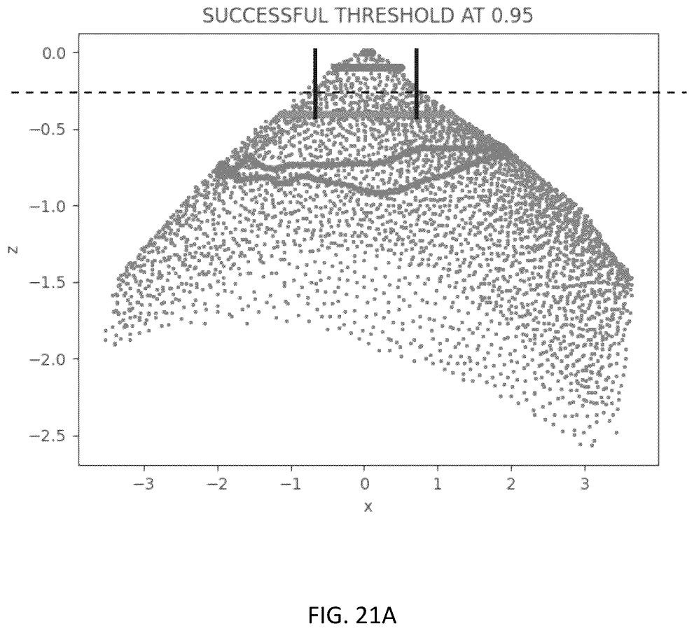

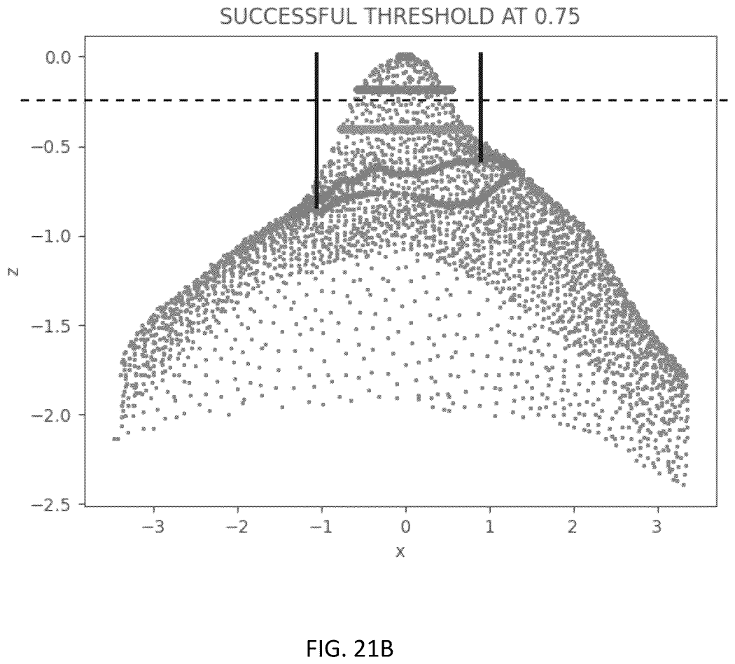

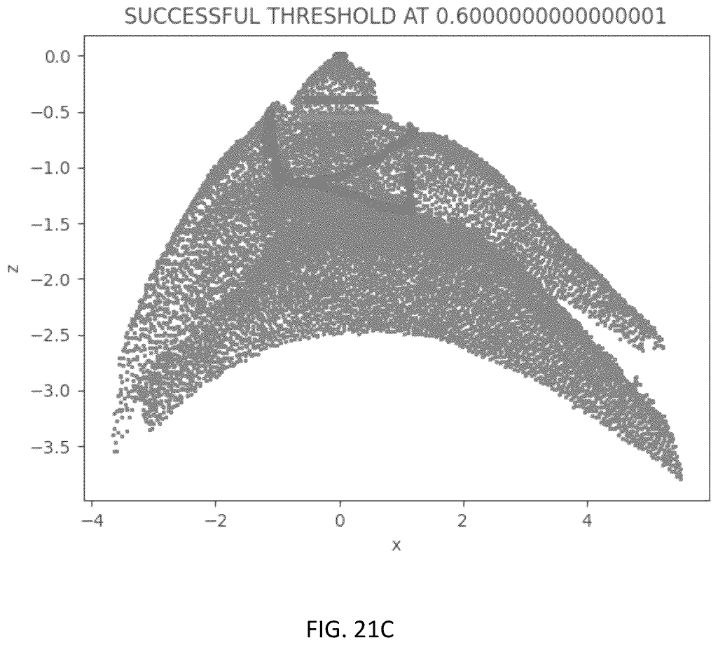

FIG. 21A is a three-dimensional point cloud showing a scanned nipple with subtle slope, according to one or more embodiments of the present disclosure.

FIG. 21B is a three-dimensional point cloud showing scan sensitivity for a scanned nipple, according to one or more embodiments of the present disclosure.

FIG. 21C is a three-dimensional point cloud showing a poorly scanned nipple, according to one or more embodiments of the present disclosure.

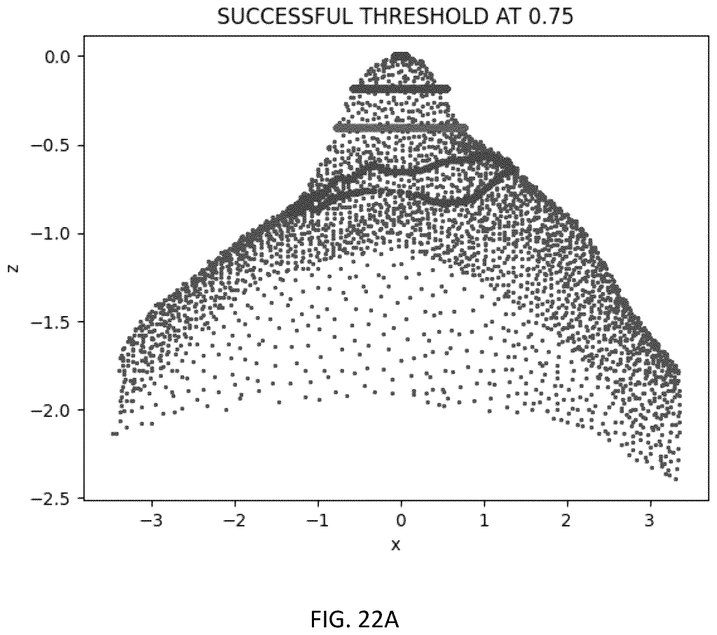

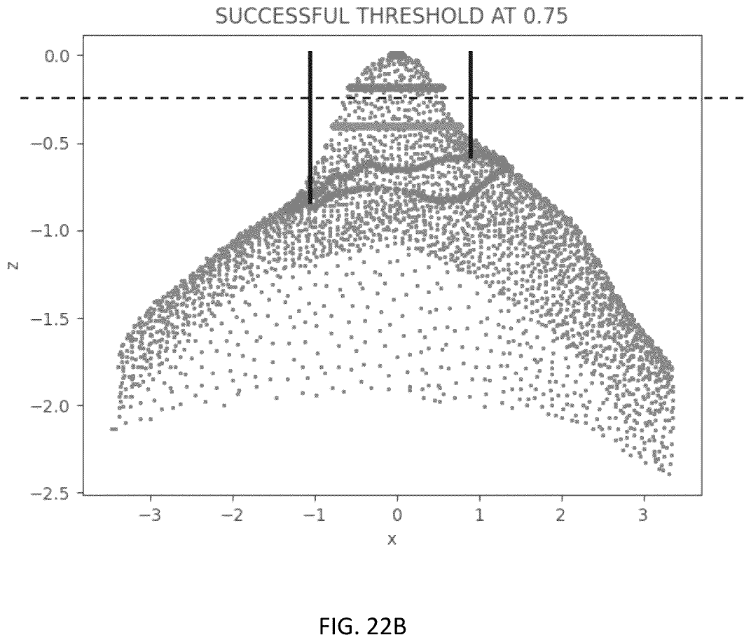

FIG. 22A is a three-dimensional point cloud of a scanned nipple with accurately described shape, according to one or more embodiments of the present disclosure.

FIG. 22B is a three-dimensional point cloud showing inaccurate base width, according to one or more embodiments of the present disclosure.

FIGS. 22A and 22B illustrate that the base error of scans remains above 2 mm with a deviation of 2 mm Scans shapes may be more accurately described by the predicted measurements. Additionally, while there doesn't appear to be many different clusters (types) of base widths, there does seem to be more types of shapes. In some embodiments, the tailored options are designing based on nipple shapes. In some embodiments, the tailored options based on a single dimension.

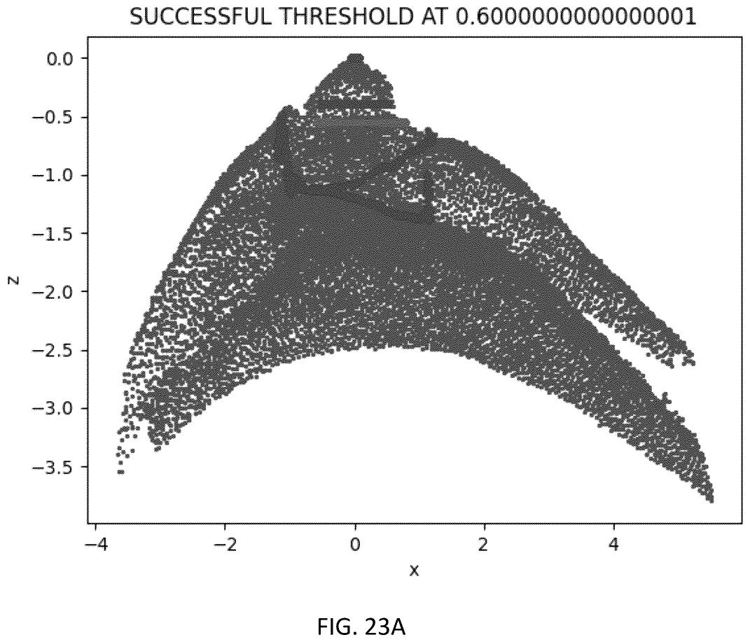

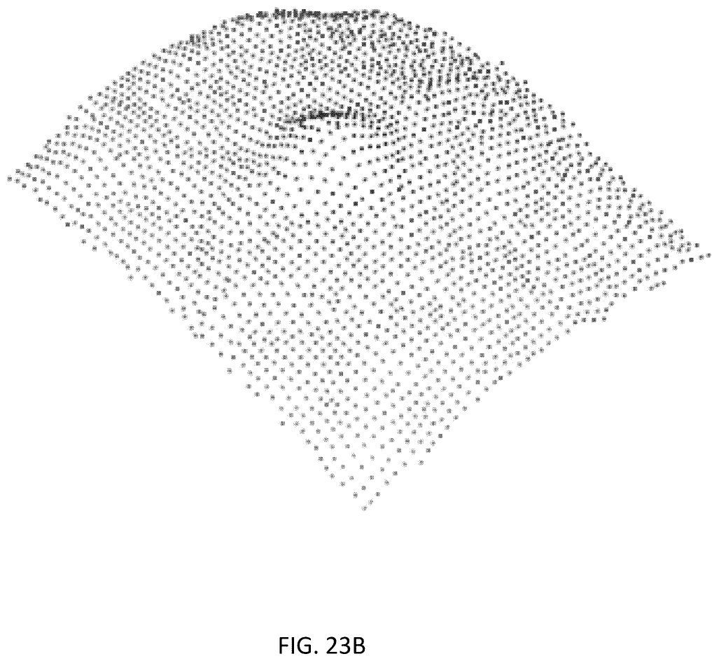

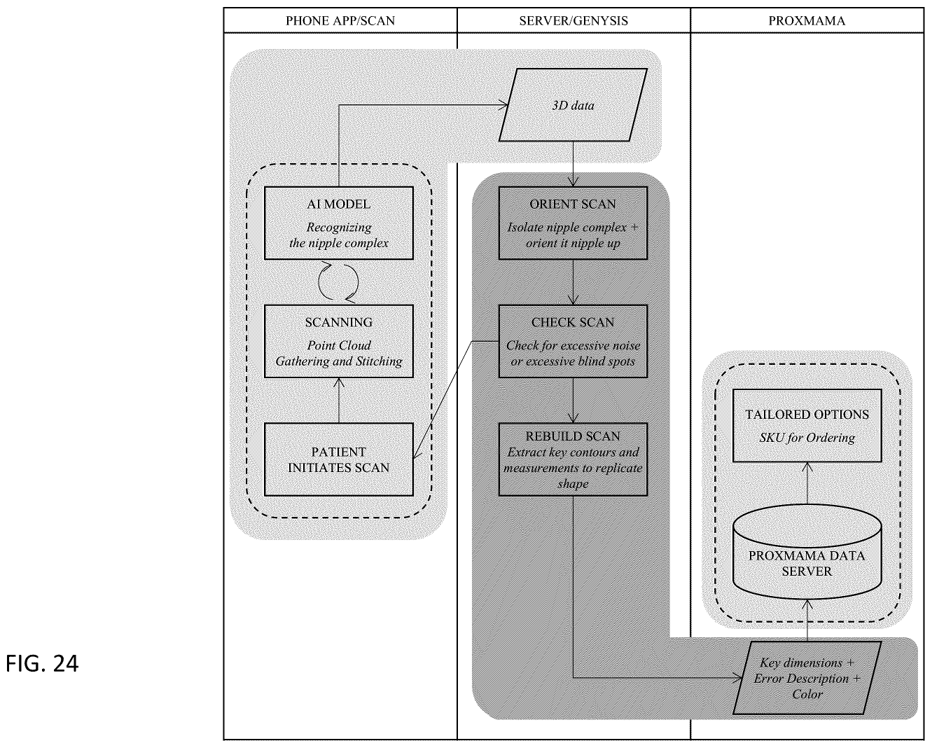

FIG. 2A is a three-dimensional point cloud showing a scan rejection due to even distribution of noise, according to one or more embodiments of the present disclosure. FIG. 23B is a three-dimensional point cloud showing a sparse point cloud resulting from an acceptable scan, according to one or more embodiments of the present disclosure. The algorithm may reject scans that are clearly too noisy, even if that noisy scan is “evenly distributed.” Simultaneously, the algorithm should be able to deal with sparse point clouds that are well distributed. By attaching algorithm sensitivity to point cloud sparsity, it may increase accuracy and decrease rejection rates.

Once the data is processed, measurements and predictions may be clustered separately and see how well they overlap. If base width measurements do not create significant clusters or cannot robustly be predicted, clustering by shape may instead be considered.

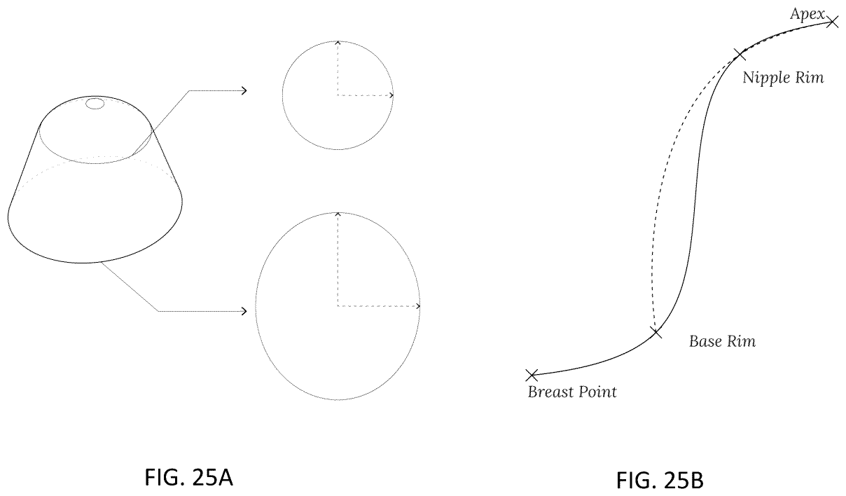

FIGS. 25A and 25B shows that the algorithm module 140 can extract four dimensions to accurately define a nipple's shape. The scan optimization module 120 may gather profile data at one or more (e.g., 4) points to extract one or more (e.g., 2-4) major dimensions of the nipple and/or breast.

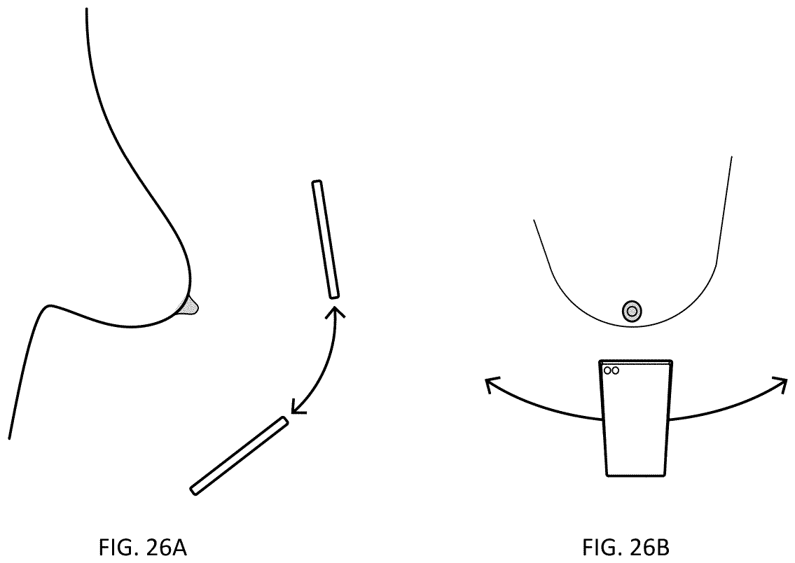

FIGS. 26A and 26B illustrates that in the previous phase two valid strategies for scanning were identified: Pitch and Yaw. In this pha'se, these methods were compared using the user's “same hand” and “opposite hand” relative to the breast being scanned.

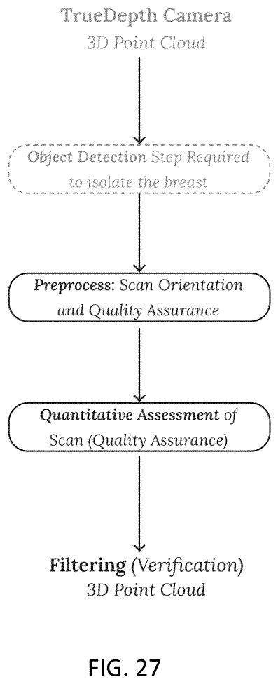

FIG. 27 illustrates details of the scanning strategy, or the process in which the user will be asked to gather a point cloud. Yaw may refer to side to side movement (medial to lateral). Pitch may refer to up and down movement (distal and proximal). Filtering may be removal of certain parts of a scan based on certain features (vertex angle). Marching cubes may be an established algorithm for rebuilding point clouds as meshes for 3D printing.

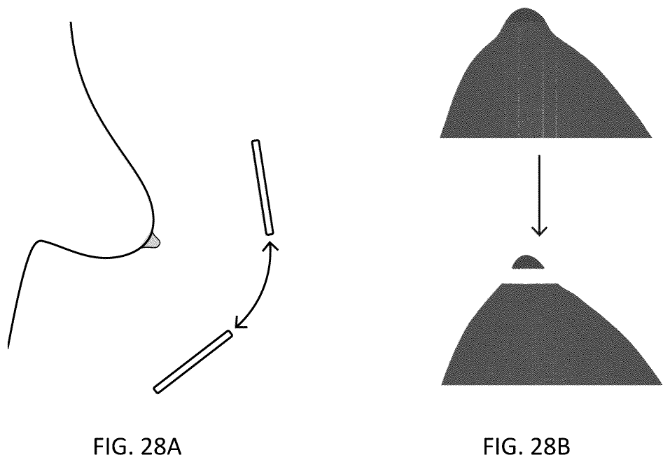

FIG. 28B is a diagram illustrating the potential axes of movement for scanning, which may be yaw, or side to side, or medial to lateral movement; pitch, or up and down, or distal and proximal movement; or roll movement, according to one or more embodiments of the present disclosure.

FIG. 26D shows a three-dimensional model illustrating the marching cubes algorithm, an established and computationally intensive algorithm for rebuilding point clouds as meshes for 3D printing, according to one or more embodiments of the present disclosure.

FIGS. 28A and 28B shows that in some embodiments, the scanning application 130 can request the user to perform scanning based on a pitch strategy where the user holds her breast upwards to ensure proper angle and scans with her opposite hand. The scanning application 130 may request the user to hold their breast to identify movement, nipple pitch, and/or breast size. In some embodiments, the scanning application 130 requests the user to stimulate her nipple, hold her breast upwards towards the frontal plane with the same hand, and/or scan the nipple in pitch getting the under-breast areas as well. For example, the scanning application 130 can display the requests to acquire user variables such as nipple pitch, nipple placement and breast sag.

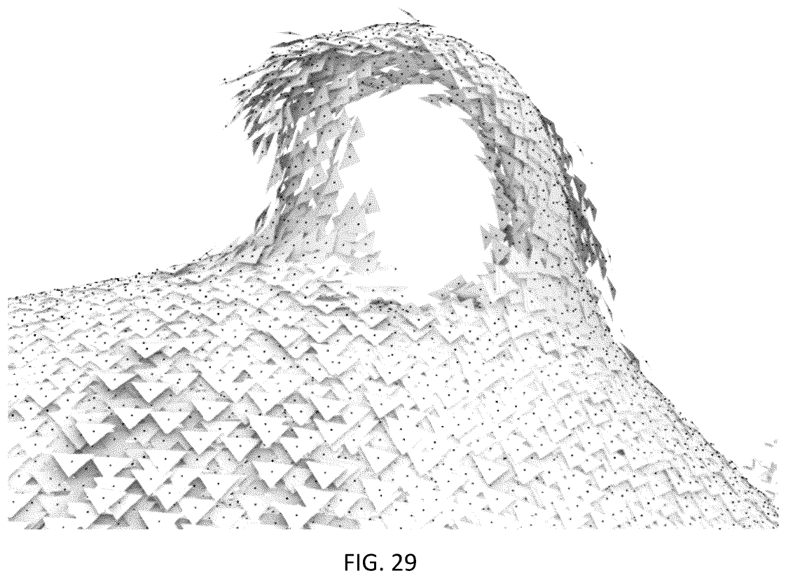

FIG. 29 shows that, at the top edge of the nipple, module 120 may identify and handle noise that may increase the apparent top diameter of the nipple's peak.

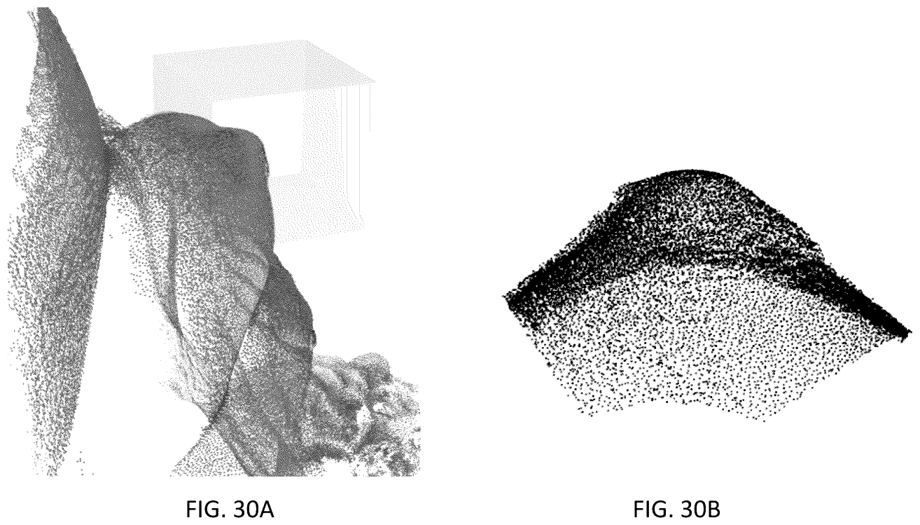

FIGS. 30A and 30B shows orienting the scanned area in the correct direction. The input comes in at an arbitrary direction with the area of interest marked in a bounding box.

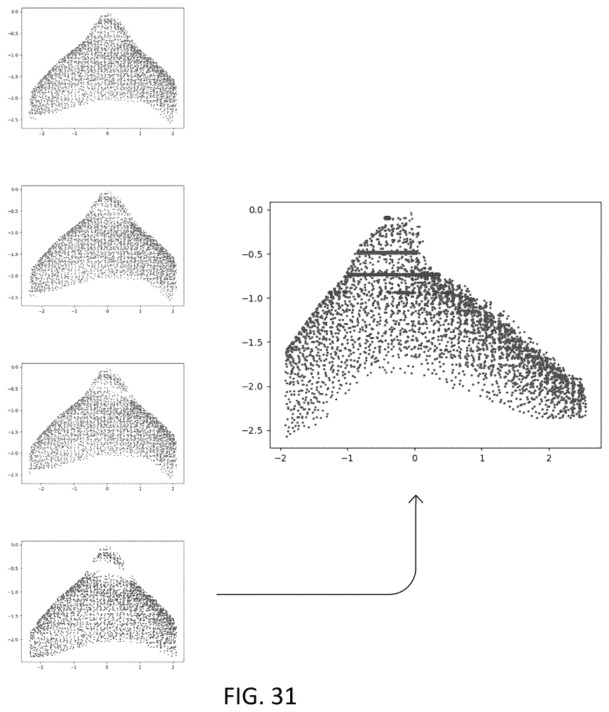

FIG. 31 shows that the scan optimization module 120 may account for the range of nipple peaks available. By filtering the point cloud in steps, algorithm module 140 may take care of most nipples with lower peaks.

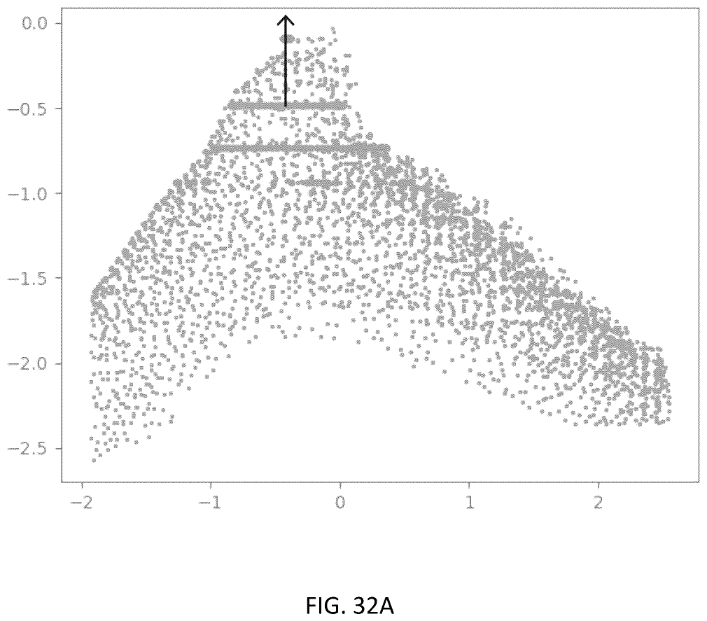

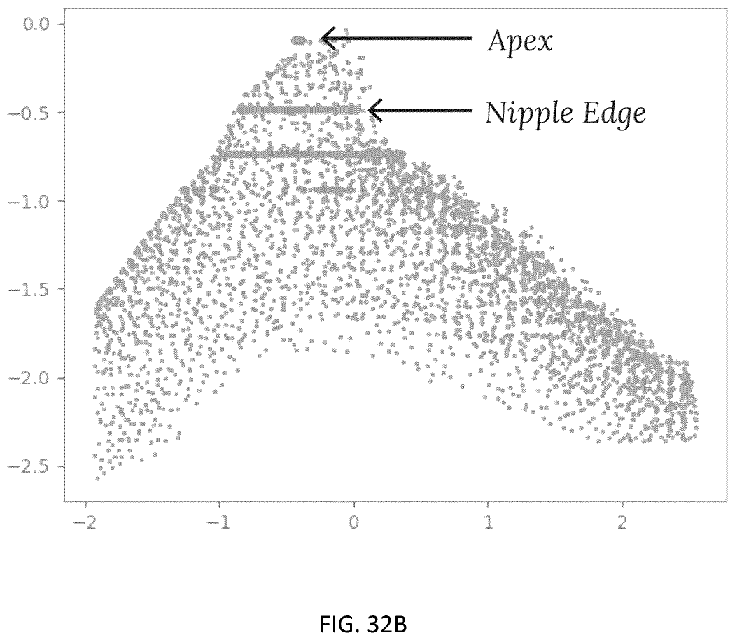

FIG. 32A shows that, once the base of the nipple and top rim of the nipple are isolated additional contours are placed on the surround breast to give a more accurate estimation of the nipple's curvature. Algorithm changes include new ways to deal with changing nipple peaks, nipple edge noise and random orientations. In some embodiments, features of the algorithm module 140 may include automated orientation. In some embodiments, features of the algorithm module 140 may include not meshing the scans. In some embodiments, features of the algorithm module 140 may include step-wise filtering. In some embodiments, features of the algorithm module 140 may include lining up contours.

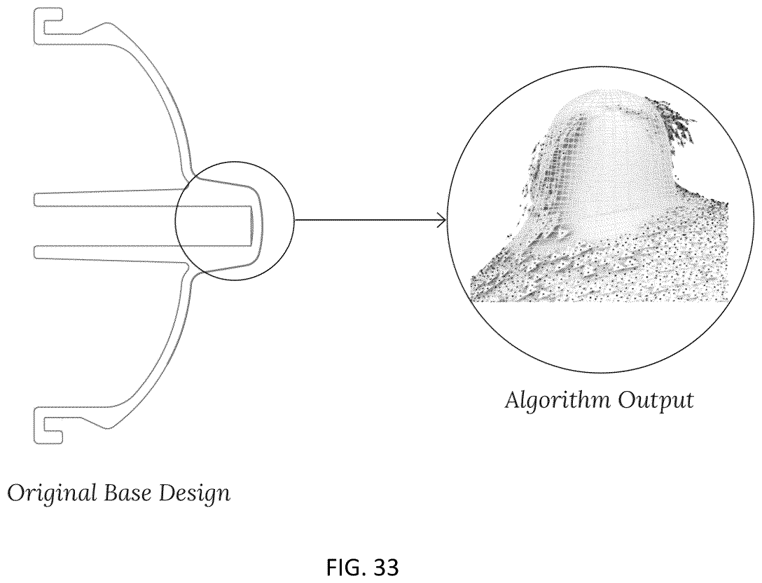

FIG. 33 shows nipple structures that may be evaluated. Zero peak angle patients may be evaluated. Another approach is to stimulate patients' nipples further. Module 120 may assume that center of the apex will more or less be in line with the center of the nipple radius. Module 120 may identify that the additional pressure of holding the breast affect the nipple geometry and or result in squirting.

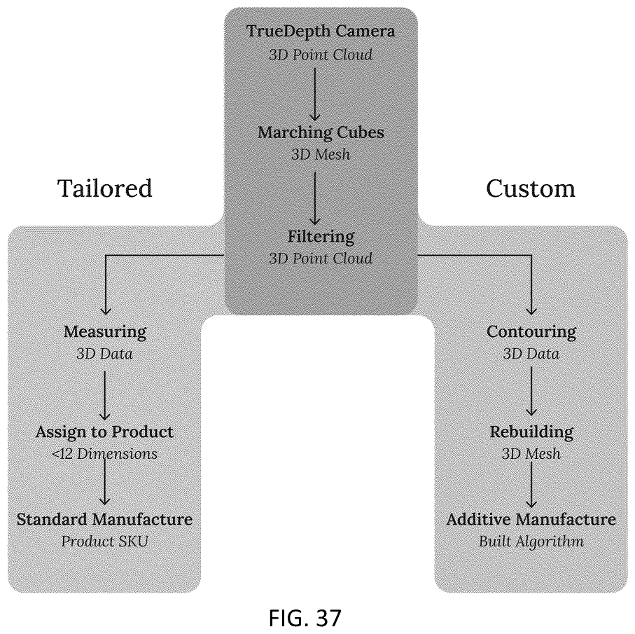

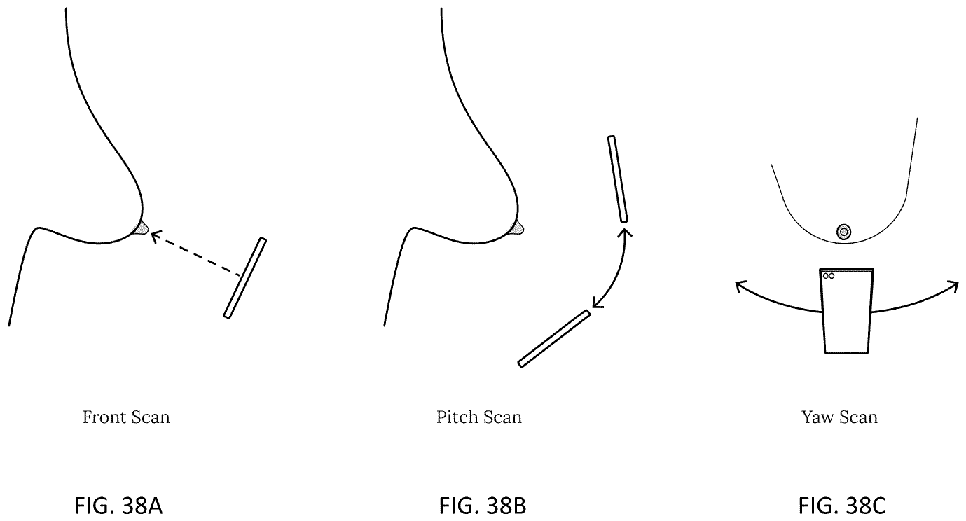

FIG. 37 shows an embodiment in which the scan optimization module 120 can extract four dimensions to accurately define a nipple's shape. While the areola diameter itself may not be necessary, the dimensions of the nipple's “base” (from a geometric standpoint) is important as it determines its overall shape independent of its diameter. The scan optimization module 120 may estimate the x-diameter and y-diameter of the nipple's top surface and base. Three different sizes for each dimension may result in up to 12 different products to choose from.

### Single Frame

The scan optimization module 120 may identify or receive a single frame, which may refer to a single image of a scene, whether it is from a recording or a photo.

### Stitching Scans

The scan optimization module 120 may perform stitching by collecting depth information from multiple frames and stitching them together.

### Blind Spots

The scan optimization module 120 may identify blind spots that may be important locations covered or otherwise unseen by a single frame.

### Curve Interpolation

The scan optimization module 120 may identify marching cubes that may be established algorithm for rebuilding point clouds as meshes for 3D printing.

### Marching Cubes

The scan optimization module 120 may perform curve interpolation or curve fitting, which may include estimating the appropriate curve to represent a series of points.

The scan optimization module 120 may resolve variables through algorithmic design and input included breast splay and sag. The scan optimization module 120 may take scans from the frontal plane of the nipple to calculate splay and identify sag.

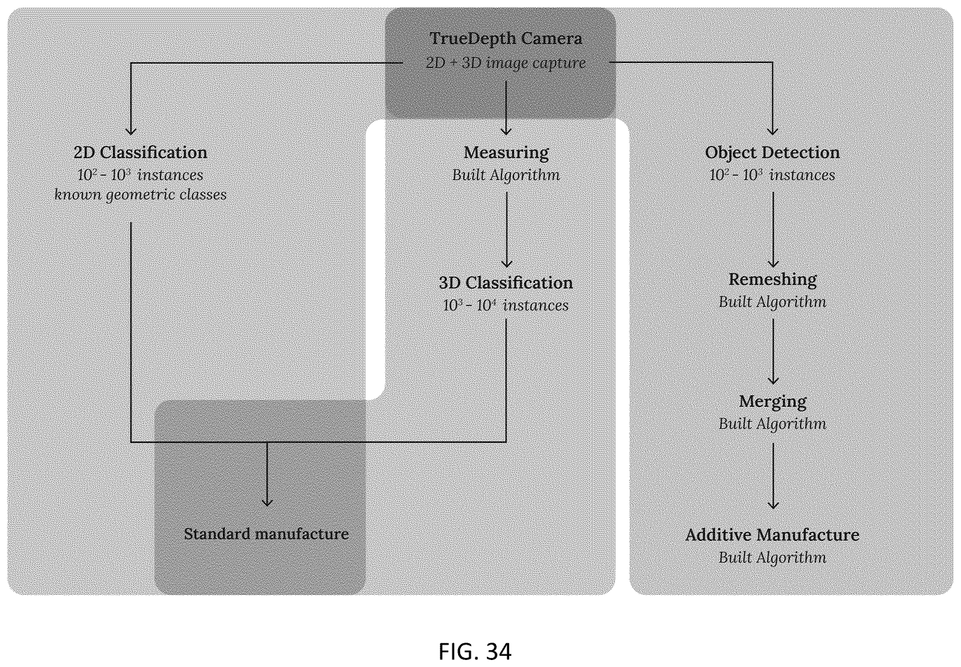

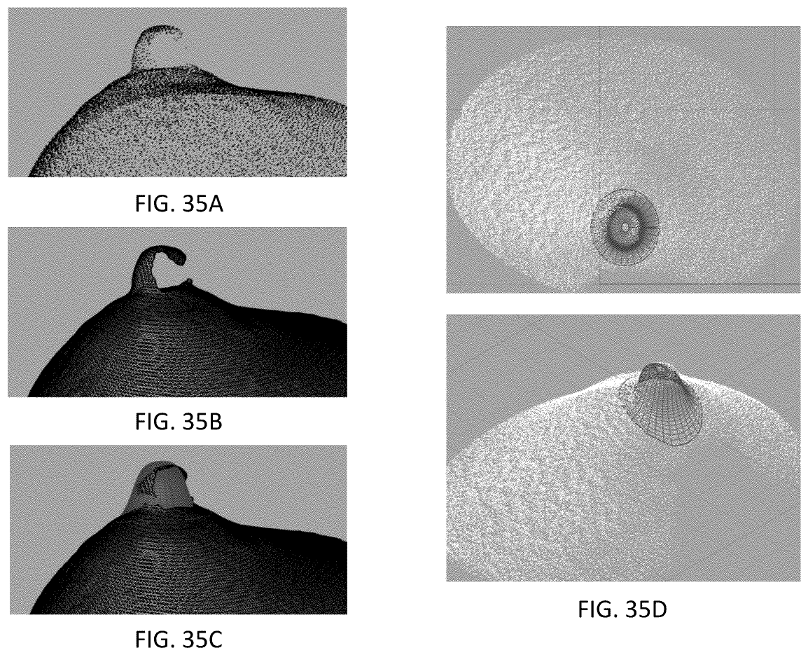

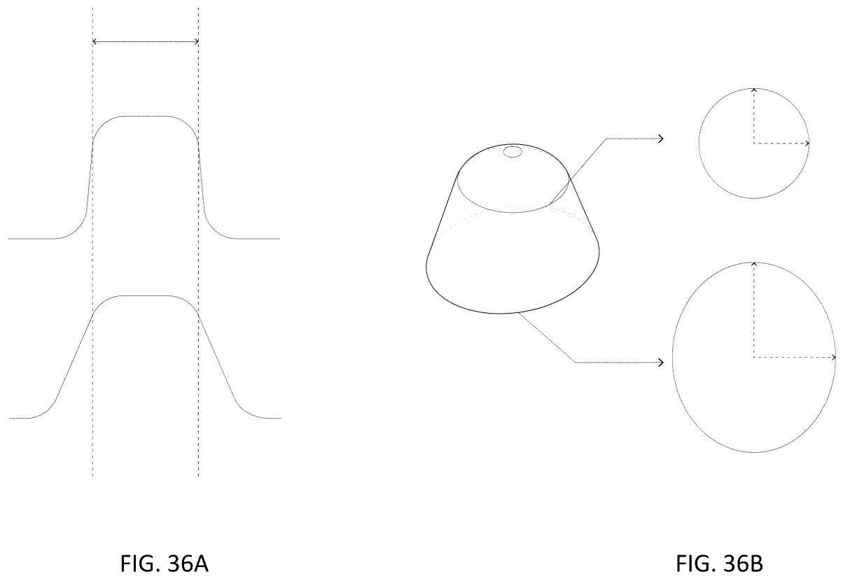

FIG. 34 shows an embodiment of a flow of the scan optimization module 120 based on remeshing a point cloud, filtering out certain faces to identify landmarks then fill in blind spots successfully replicated most of the scanned nipples provided. The scan optimization module 120 may maintain an effective process for obtaining and checking scans to capture the entirety of the breast. The scan optimization module 120 may identify unique and distinct nipple designs based on the nipple's four dimensions and the surrounding breast curvature.

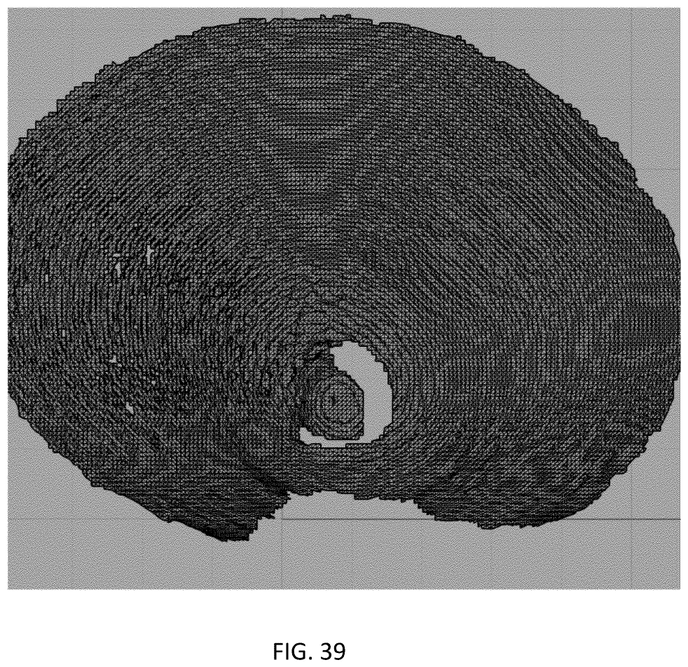

FIG. 39 shows that the module 120 may translate the point cloud into a digestible mesh for processing point clouds.

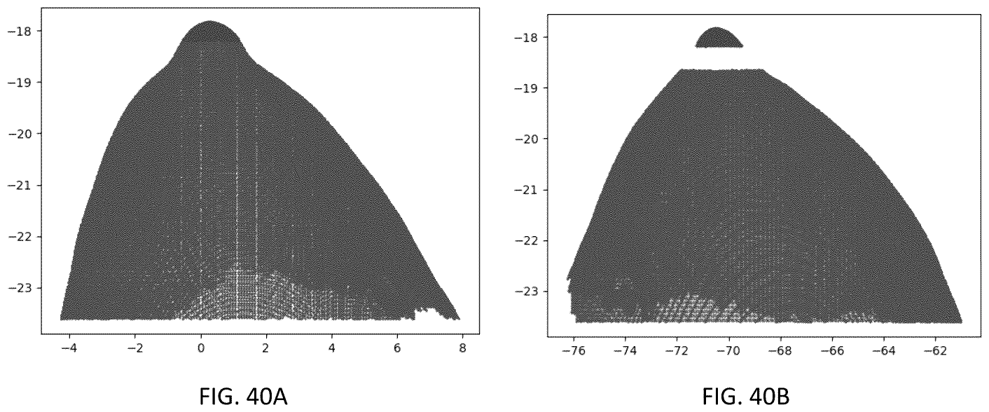

FIGS. 40A and 40B show that, after the scan is meshed, the module 120 may cause the breast nipple to be oriented upwards and faces are removed that are angled too far away from the central axis. Module 120 may isolate the base of the nipple and the top of the nipple.

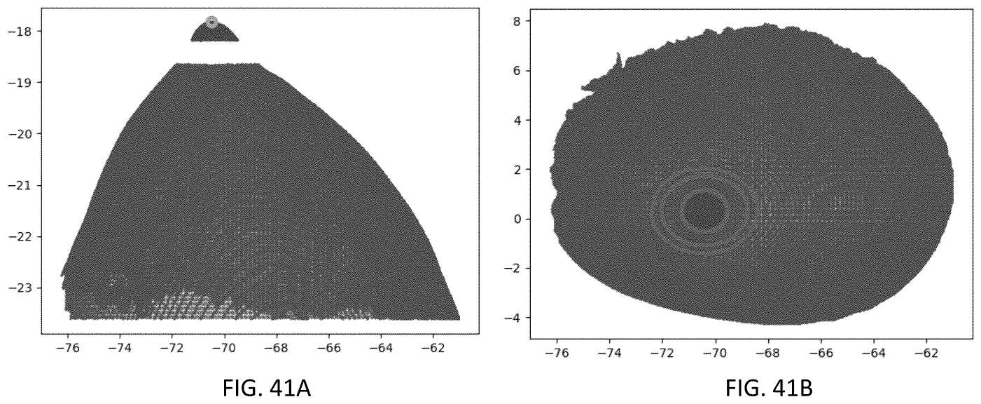

FIGS. 41A and 41B show that, as the base of the nipple and top rim of the nipple are isolated by the module 120 for measuring, module 120 may cause additional contours to be placed on the surrounding breast to calculate an accurate estimation of the nipple's curvature.

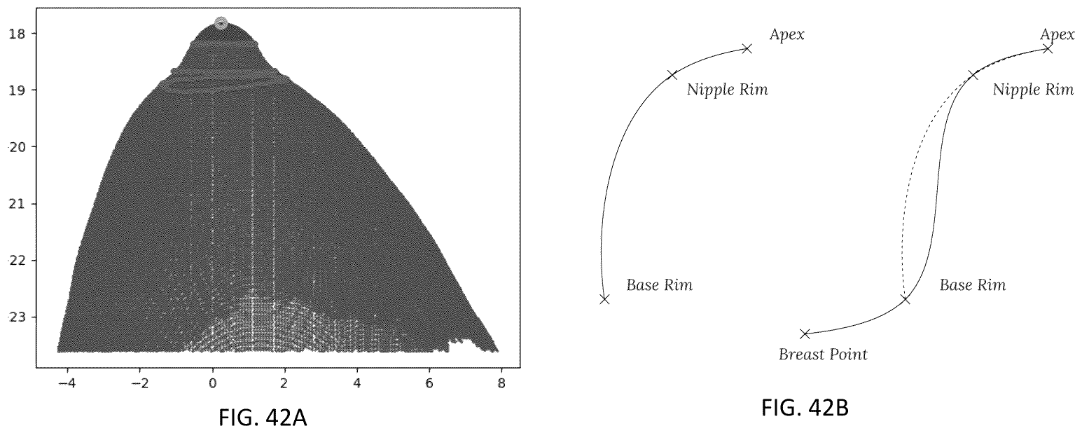

FIGS. 42A and 42B show that, once the base of the nipple and top rim of the nipple are isolated by the module 120 for contouring, module 120 may cause additional contours are placed on the surrounding breast to calculate an accurate estimation of the nipple's curvature.

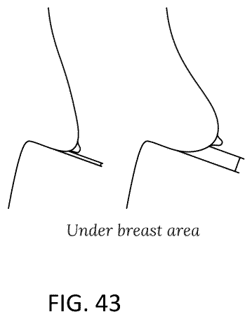

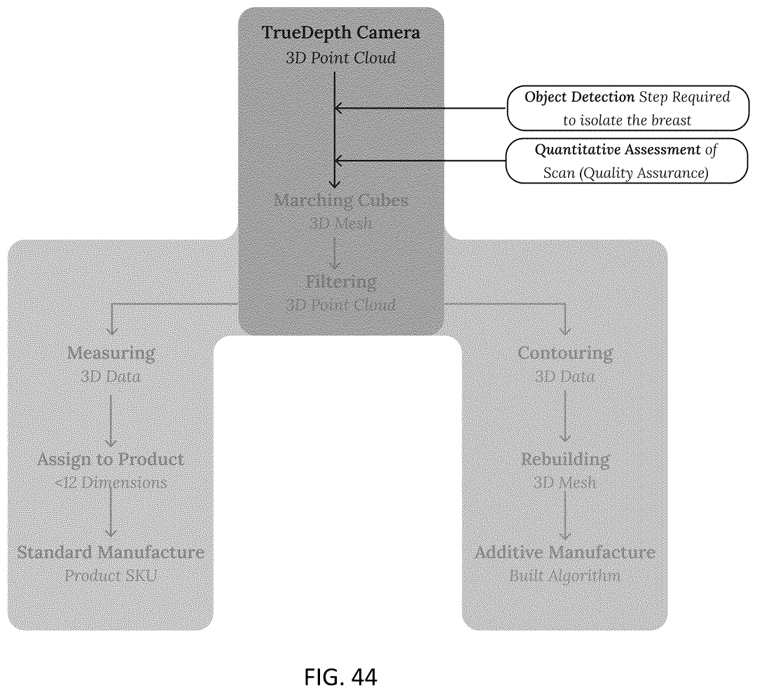

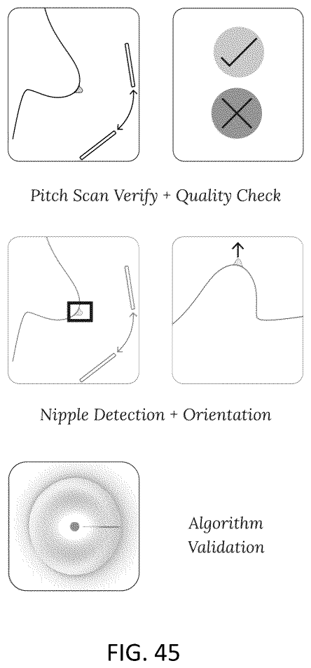

FIG. 43 shows module 120 may calculate or identify variables measuring nipple anatomy may come from the surround breast. In that regard, module 120 may identify blind spots underneath the breast and at the proximal side of the nipple. Module 120 may receive images taken via the pitch scanning process.

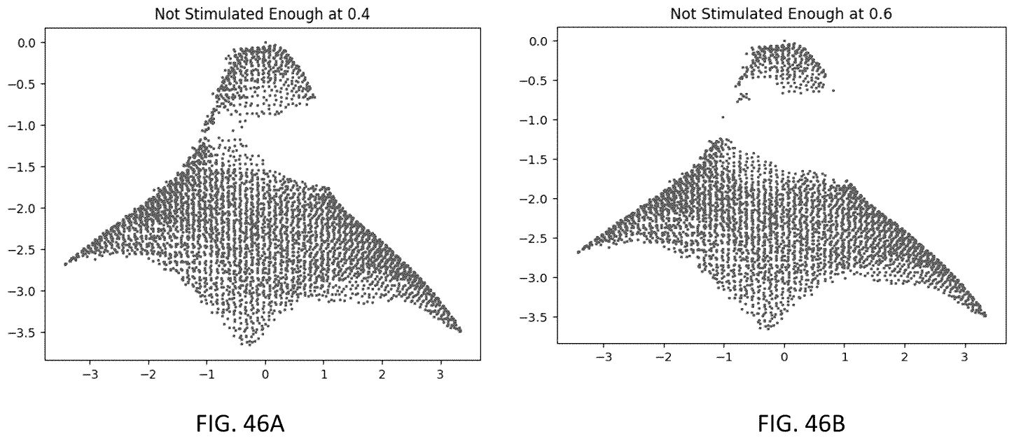

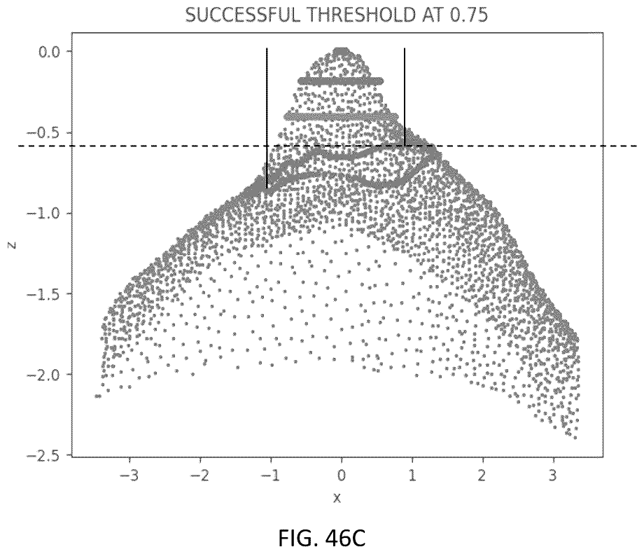

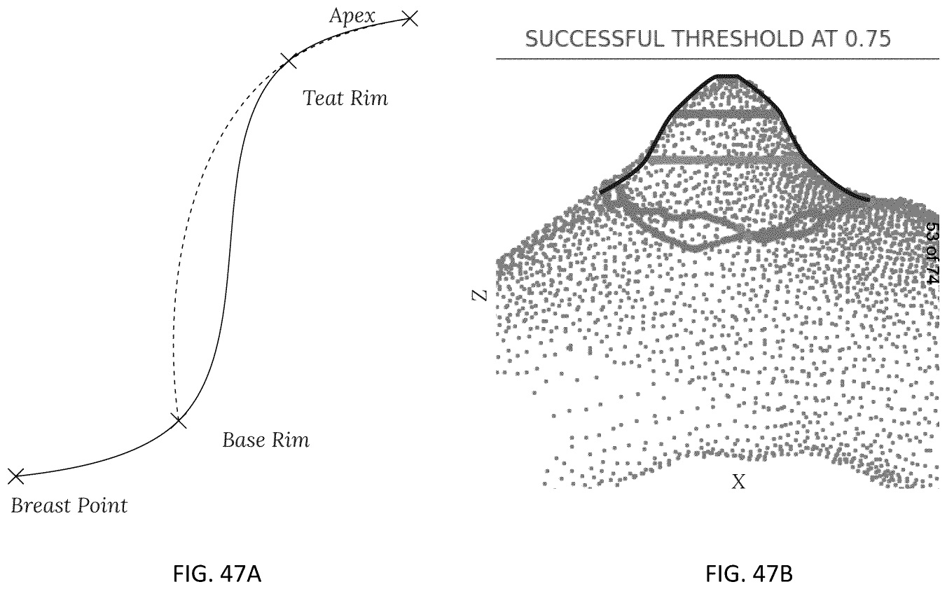

FIG. 46A-46C shows that the scan optimization module 120 may measure the base width. In some embodiments, the scan optimization module 120 may generate a custom shape of the breast for 3D printing. The scan optimization module 120 may cause nipple shape to be defined by breast points located 110% further from the origin than the base radius, the base rim, teat rim and the apex. While the sensitivity measured by the algorithm module 140 may add significant variation in measurements, the scan optimization module 120 may identify the shape of the nipple and/or breast in all scans. Sensitivity may refer to the threshold for defining a “gap”. For example, a more sensitive parameter on the same scan may sense a gap at 0.4, while and less sensitive parameter would only detect a gap at 0.8. The optimal threshold varies from patient to patient and scan to scan to varying degrees of certainty.

The goal of clustering data may be to obtain meaningful (distinct) groups of parameters for identifying the nipple and/or nipple profile.

### Terms

Invalid Scans may be scans that do not clearly show a nipple that may be detected before running the algorithm.

Rejected Scans may be scans that are rejected by the algorithm as a result of the inability for proper processing.

Sparsity may be cloud sparsity that refers to the density of points defining a point cloud. Sparsity may be directly affected by how long patient scans her breast.

Base Clusters may be single parameter groupings determined by the base width.

Shape Clusters may be multi-parameter groupings determined by the base width, teat width, base height, teat height and breast landmarks.

The scan optimization module 120 may cause scans to be rejected for scanning sparsity or holes, base not detected, excessive noise, major blind spots. The scan optimization module 120 may provide the feedback to the scanning application 130. The scanning application 130 may display errors to provide feedback. For example, feedback may indicate scan longer/move camera, remember to stimulate nipple, please make sure to keep still, please try to capture the entire nipple.

The scan optimization module 120 may include, or access labeled images for teats, nipple complex, and frames. The scan optimization module 120 may include or access point cloud images that are labeled.

The scan optimization module 120 may analyze slightly “sharper” breasts with little to no stimulation to capture the correct shape of the nipple.

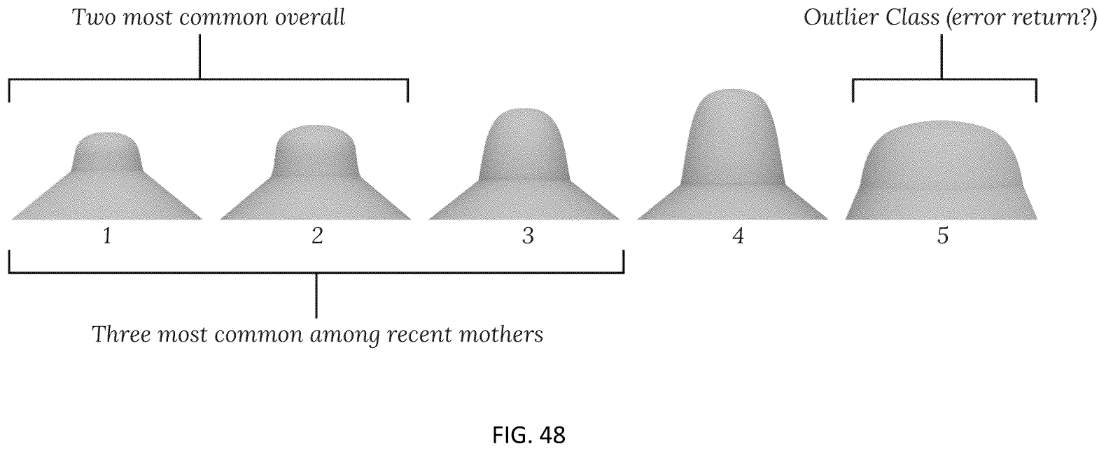

FIG. 48 shows 5 example classes of nipples. Each class may represent geometric features of actual nipples. Each class may be a size and/or shape of a nipple on the baby bottle.

By connecting algorithm sensitivity to sparsity and tweaking sensitivity, the scan optimization module 120 may improve the algorithms rejection rate significantly. The scan optimization module 120 may handle sparsity. In some embodiments, the scan optimization module 120 may handle sparsity based on a time requirement. For example, time between each image or scan.

The scan optimization module 120 may avoid false positives by adding a “filter” that only register frames if both the nipple complex and teat are found within a certain range of one another in the images.

Another way for the scan optimization module 120 to increase recall or improve false negatives is to lower the confidence threshold used by the scan optimization module 120.

In some embodiments, the scan optimization module 120 may combine the confidence threshold and a limit on the number of teats and nipple complexes detected in the frame and filter.

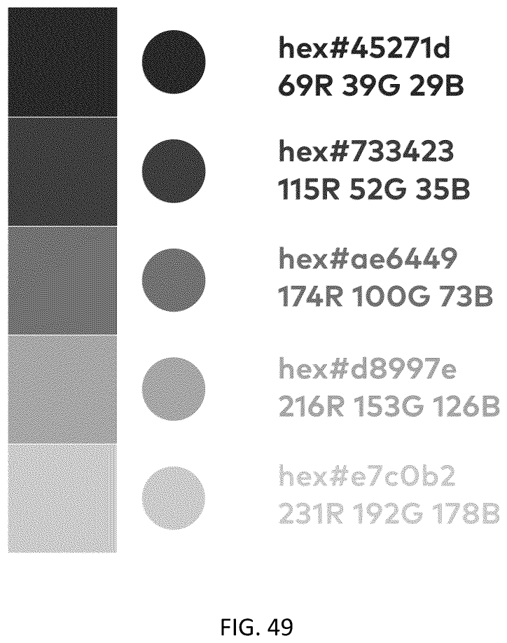

FIG. 49 shows example predetermined (e.g., swatches) of nipple and/or breast colors. For example, the custom mouthpieces may have any of the predetermined colors. The scan optimization module 120 may detect the color of the nipple and/or breast in the images. The scan optimization module 120 may compare the detected color to the predetermined colors. The scan optimization module 120 may select, based on the comparison, a predetermined color that matches the detected color to create a baby bottle having a mouthpiece with a color that matches the color of the actual breast and/or nipple.

In some embodiments, the scanning application 130 may receive a selected color from the user. For example, the user may want to use the scanning application 130 and/or the scan optimization module 120 to determine an optimal mouthpiece category but the user may want to select the color of the mouthpiece instead of relying on the scanning application 130 and/or the scan optimization module 120 to detect the color. The scanning application 130 may transmit the color to the scan optimization module 120. The scan optimization module 120 may determine the dimensions of the breast and nipple without having to detect the color. The scan optimization module 120 may determine the mouthpiece category without detecting the color. The scan optimization module 120 may transmit the selected color to the manufacturing device 105 to prepare the user's bottle with the selected color. The scan optimization module 120 may transmit the selected color and the determined size to prepare the user's bottle 103.

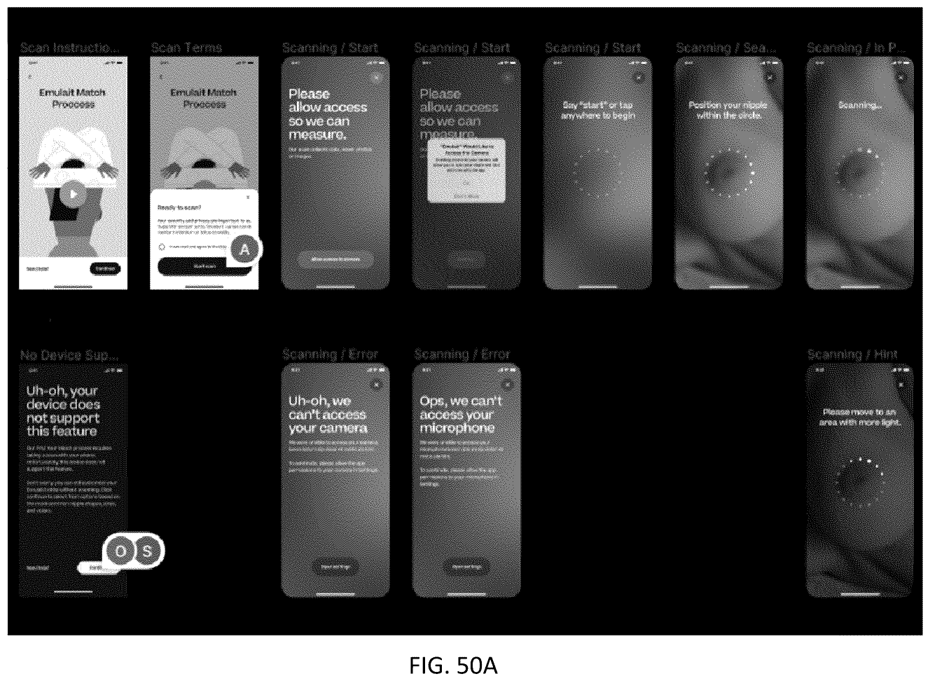

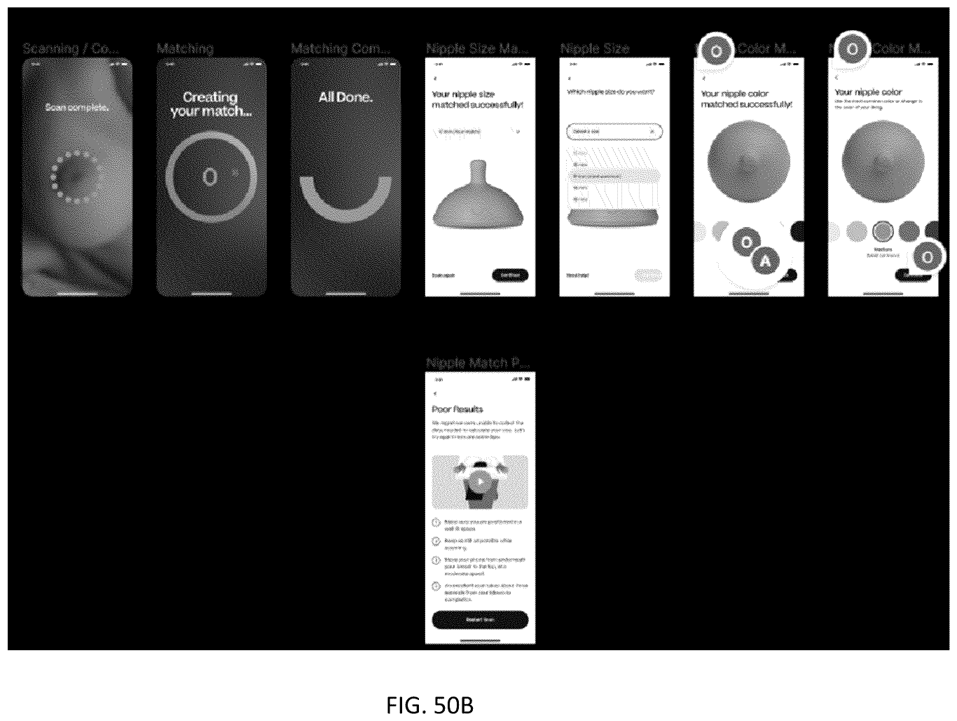

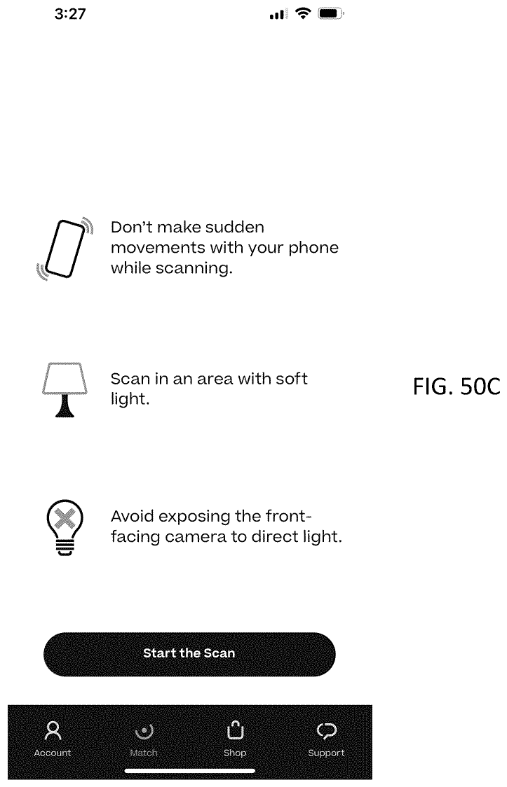

FIGS. 50A and 50B show an example user interface of a nipple scanning application. FIG. 50C shows an example user interface including instructions for scanning the breast and/or nipple with the camera 110 of the client device 104.

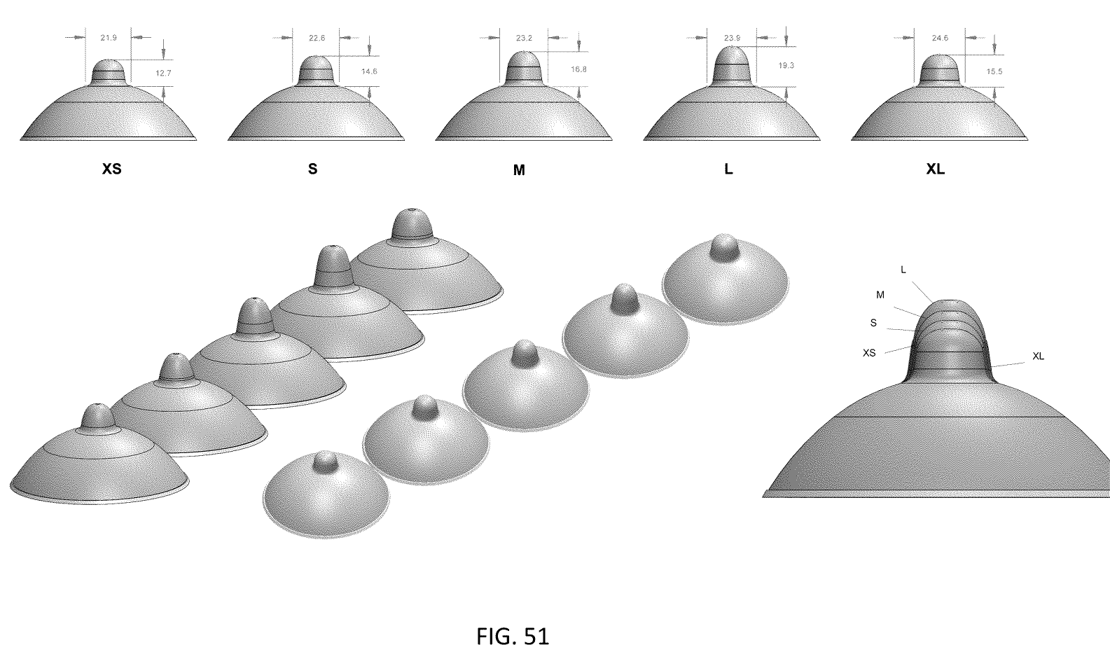

FIG. 51 shows embodiments of predetermined mouthpieces of varying dimensions, sizes, and shapes. Each mouthpiece may include a nipple and a portion of a breast. The scan optimization module 120 may detect the dimensions of the user's breast in the images. The scan optimization module 120 may compare the detected dimensions to the predetermined dimensions. The scan optimization module 120 may select, based on the comparison, a predetermined mouthpiece that has dimensions that match the detected dimensions to create a baby bottle having a mouthpiece that matches the dimensions of the actual breast and/or nipple.

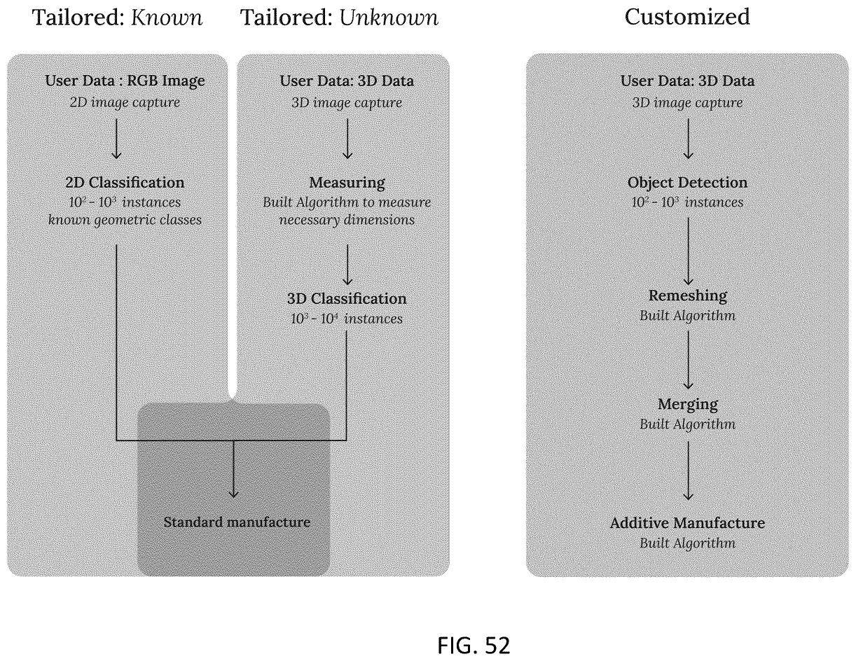

FIG. 52 shows a tailored approach to replication compared to a customized approach. For example, the tailored approach may include identifying dimensions and colors of the user's breast to match them to predetermined mouthpiece and colors. The customized approach may include identifying dimensions and colors of the user's breast for manufacturing and/or printing an on-demand baby bottle for the user. The scan optimization module 120 may be used for both the tailored and custom techniques.

### Single Frame

In some embodiments, the scan optimization module 120 may identify or receive a single frame. The single frame may include a single image of a breast and/or nipple. For example, the single frame may be from a recording or a photo.

### Stitching Images

In some embodiments, the scan optimization module 120 may collect and/or identify information from one or more images. The scan optimization module 120 may combine the information from the one or more images. For example, the scan optimization module 120 may stich together the one or more images into a composite image.

In some embodiments, the scan optimization module 120 may identify blind spots in the images. For example, the scan optimization module 120 may identify important locations on the breast and/or nipple that covered or otherwise unseen in a single frame. Based on the blind spots, the scan optimization module 120 may cause the scanning application 130 to display additional requests to scan the breast.

### Noise

In some embodiments, the scan optimization module 120 may identify one or more errors (e.g., noise) in the one or more images. The scan optimization module 120 may identify the one or more errors due to material reflectivity, image resolution, camera sensitivity, and/or other environmental factors.

### Smoothing

In some embodiments, the scan optimization module 120 may remove the identified one or more errors automatically to create cleaner and more accurate 3D image (e.g., meshes) without floating points and other errors.

In some embodiments, the scanning application 130 may generate the 3D image in file types for point clouds such as: .usdz, .ply, .obj, and .xyz. In some embodiments, the scanning application 130 may transmit the files in the file types to the scan optimization module 120. In some embodiments, the scan optimization module 120 may store the 3D image in file types for point clouds such as: .usdz, .ply, .obj, and .xyz.

Potential overhangs in nipple geometries may cause blind spots in scans. The scan optimization module 120 may prevent blind spots to ensure accurate remeshing of the scan directly. The scan optimization module 120 may determine depth measurements from the top of the nipple.

Structured light may deal with noise from the surface of the object being scanned.

The magnitude of this noise may be determined from the surfaces angle to the camera, the surface material and more.

Marching cubes for rebuilding point cloud scans from vertically rebuilding the scan with 3D pixels (voxels) like a topography map.

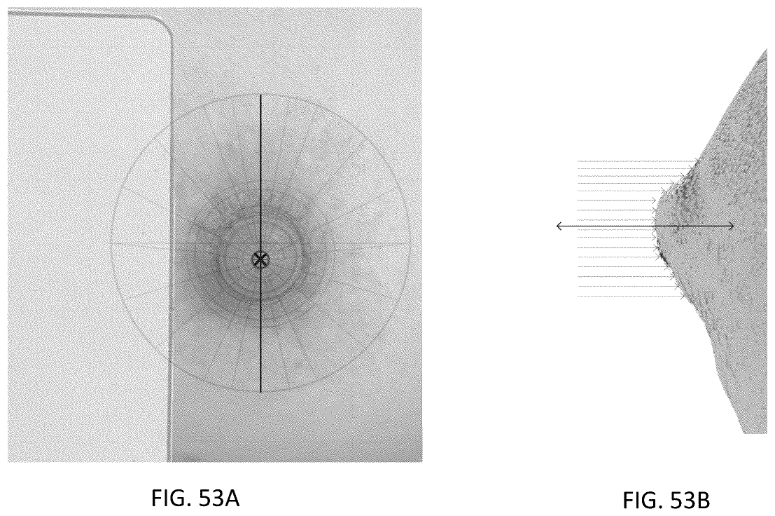

FIGS. 53A and 53B shows rebuilding geometry was through outlining the lateral profile of the nipple and rotating it around the nipple's central axis. Structured light is appropriate.

Marching cubes and contour rebuilding may deal with noise, blind spots, and measurements with only a single photo. For example, three measurements from point cloud outputs.

Data is gathered to recognize the nipple in a frame, isolate its features and create the outer skin automatically. Estimate the three dimensions and merge nipple color information with point clouds.

In some embodiments, the scan optimization module 120 may identify the color of the nipple. In some embodiments, the scan optimization module 120 may identify the color of the breast.

As shown in FIG. 14, non-framing methods may include the scan optimization module 120 quantifying the color of different regions in an image. By identifying the gray scale value of nearby pixels, the scan optimization module 120 may create a quantifiable metric for evaluating color similarity. A technical improvement may include removing the need for perfect frame lineup between 3D Scan and 2D frame. Another technical improvement may be avoiding the need for image flattening or post-processing. Another technical improvement may be extracting the color regardless of the surrounding light in the images.

### Displacement Map

Map may isolate the pigments of a scene a normal map may be derived from shadow and highlight information.

### Procedural Colors

The scan optimization module 120 may generate procedural colors that are representative of a color created using a mathematical description rather than directly stored data.

### Color Analysis

The scan optimization module 120 may perform color analysis to characterize regions in an image by their color content.

### Sample Patch

The scan optimization module 120 may identify a sample patch as the region in an image that may be selected for analysis. The algorithm module 140 may compare one or more sample patches in various places in the images. Based on the comparison, the scan optimization module 120 may extract regional differences.

### Intensity Map

The scan optimization module 120 may generate an intensity map that may indicate a certainty parameter for certain features based on the gray scale images. For example, the intensity map may indicate where a certain feature is “strongest” and which is “weakest” based on a gray scale image.

### Varied Colors

The scan optimization module 120 may identify a solid color and/or a varied shade of colors across each nipple and/or breast. The scan optimization module 120 may identify the change in intensity of each color as they approach the apex of the nipple.

### Lighting

The scan optimization module 120 may identify the intensity of light in the image scan. For example, the user may scan their breast in various lighting condition. In another example, the scan optimization module 120 may identify changes in lighting during the scan (e.g., user moves or turns on/off lights). The scan optimization module 120 may identify changes in lighting based on region of the breast being scan (e.g., top of breast receives more light exposure than bottom of breast, which may affect the appearance of one side of the breast from another).

### Camera Angle

The scan optimization module 120 may identify the angle of the camera 110 during the scan. For example, the scan optimization module 120 may identify angle as the user moves the client device 104 upwards in pitch relative to the breast. The scan optimization module 120 may identify if parts of the nipple are obfuscated. For example, the scan optimization module 120 may request another scan if parts of the nipple are obfuscated in the images.

### Camera Distance

The scan optimization module 120 may identify a variable amount of noise at the apex of the nipple. The scan optimization module 120 may adjust the 3D image based on the detected noise.

### Embodiment where the Angle and Distance of the Camera are Sent to the Server for Analysis

### Layered Color Maps

In some embodiments, the scan optimization module 120 may assign every 3D image including the nipple color based on the initial color analysis. In some embodiments, the scan optimization module 120 may assign each color its own intensity map to be arrayed on to the nipple scan.

### Color Analysis

In some embodiments, the scan optimization module 120 may extract a single image from by utilizing a machine learning engine 144. Once that image is extracted, the scan optimization module 120 may perform color analysis with a plurality of sample patch sizes around the nipple to generate two or more different colors of the breast and/or nipple.

embodiment when color is identified but not provided to the user or used to select nipple color. For example, the color is identified only for training the color identification model.

### Lighting

In some embodiments, the scan optimization module 120 and/or the scanning application 130 may identify the nipple pitch while the scanning application 130 collects usable scan data.

### Camera Distance

Scale of nipple in each frame may be different between users and images. By training the machine learning engine 144 (e.g., object detection model) to recognize nipples, and making the sample patch a fraction of the detected nipple's bounding box, the machine learning engine 144 may identify the dimensions of the nipple in each image that are indicative of the nipple's actual dimensions.

By identifying the color that may vary from patient to patient, the scan optimization module 120 may identify mouthpieces with colors that are personalized for the user.

### Mesh Displacement

The identified colors may be part of a bump map (rendering displacement without changing the geometry).

### Key Frame AI

The scan optimization module 120 may receive user scans and RGB images. The machine learning engine 144 may be trained to detect one or more frames for color identification and generation. The machine learning engine 144 may be trained to detect one or more nipple complexes in the images.

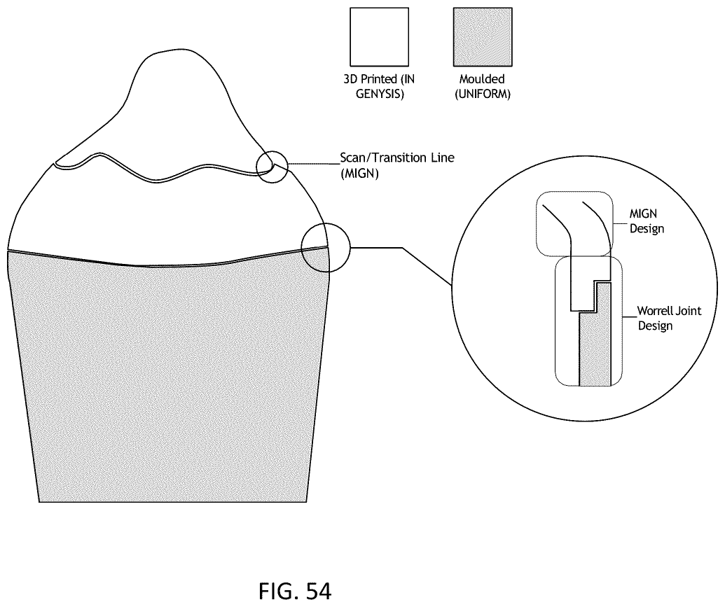

FIG. 54 shows scan optimization module 120 and/or the scanning application 130 that may identify a “transition zone” between the edge of the scan and the profile edge of the bottle 103. The scan optimization module 120 may be based on the 3D printed joint design to merge the 3D printed part to the standard manufactured bottle form.

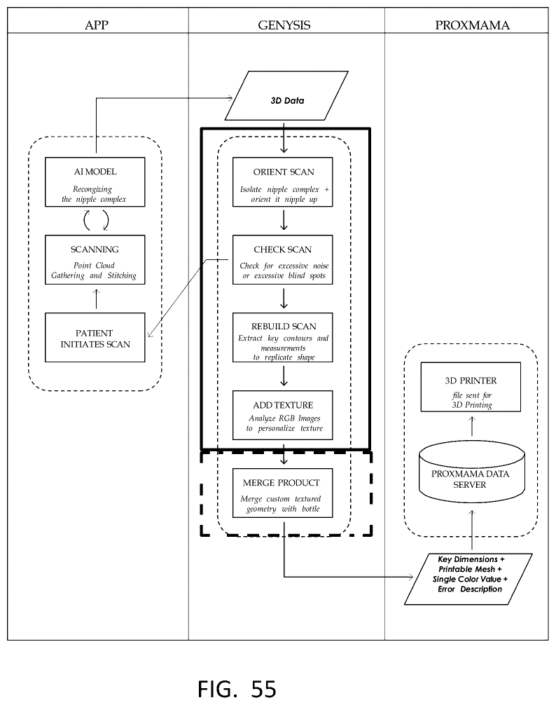

FIG. 55 shows a flow chart.

### Resolvable Noise

The scan optimization module 120 and/or the scanning application 130 may identify resolvable noise in the scan. Resolvable Noise may refer to noise that is commonplace and capable of being corrected to produce a reasonable approximation of the real nipple.

### Excessive Noise

The scan optimization module 120 and/or the scanning application 130 may identify excessive noise in the scan. Excessive noise may refer to types of noise caused by computation error, user movement, that is not predictable and requires another scan.

### User Error

The scan optimization module 120 and/or the scanning application 130 may identify user errors in the scan. In some embodiments, the user optimization module 120 can refer to error in capturing dimensions based on the physical anatomy of the user at that point in time.

### Simplification Value

The scan optimization module 120 and/or the scanning application 130 may identify the simplification value, which may be a quantitative measurement of the deviation between the output of the scan optimization module 120 and the scan of the nipple.

### Same/Opposite Hand

The scan optimization module 120 and/or the scanning application 130 may monitor the hand (e.g., left, or right) used by a user to scan their breast and/or nipple. The scan optimization module 120 may identify which breast is being scanned (e.g., left or right based on detecting a shoulder in the scan). May refer to the hand that is on the same/opposite side of the breast being scanned.

### Peak Contrast

The scan optimization module 120 and/or the scanning application 130 may identify peak contrast in the 3D images, which may be important and predictable source of variation between user input. Examples may include high peak contrast, medium peak contrast, low peak contrast.

As shown in FIG. 12, the scan optimization module 120 and/or the scanning application 130 may perform peak filtering in the images. The scan optimization module 120 may identify varying peak contrast by stepwise increasing the angle threshold until a noticeable separation is created between the nipple top and nipple base. The scan optimization module 120 may identify the nipple base and nipple top to be planar.

### Invalid Scans

The scan optimization module 120 and/or the scanning application 130 may identify and/or detect invalid scans that do not include a nipple. The scan optimization module 120 and/or the scanning application 130 may remove such images to avoid further algorithmic analysis.

### Rejected Scans

The scan optimization module 120 and/or the scanning application 130 may reject scans that are improperly scanned (e.g., nipple and/or breast not visible).

### Peak Sensitivity

The scan optimization module 120 and/or the scanning application 130 may identify the gap between the teat and the base, depending on a sensitivity metric that measures the change in points at each level.

### Base Dimension

The scan optimization module 120 and/or the scanning application 130 may identify the base width of the patient's nipple, which may be where the nipple meets the breast.

### Shape

The scan optimization module 120 and/or the scanning application 130 may identify the shape of the nipple, which may be described by the nipple's, teat width, teat height, base width, base height and apex height.

### Error

The scan optimization module 120 and/or the scanning application 130 may identify errors. The scan optimization module 120 may define the error relative to the predicted base width and the measured base width.

The machine learning engine 144 and/or the scanning application 130 may be trained on one or more frames, complexes, and/or teats.

### Apex Noise

The scan optimization module 120 and/or the scanning application 130 may identify apex noise separately from each scan as a variable amount of noise at the apex that may be accounted.

As shown in FIG. 32B, apex estimation may include the scan optimization module 120 and/or the scanning application 130 identifying that an apex of the nipple is generally aligned with the center of the nipple diameter. Nipple edge noise may be used to measure the peak of the nipple but otherwise may be ignored in calculated placement.

### Predictable Blind Spots

Scans may miss important sides of the nipple, which may create holes in the scan that make it difficult to create any meaningful approximation. The scan optimization module 120 may identify the blind spots. The scan optimization module 120 may predict the blind spots and the data contained therein.

FIG. 56 shows planar interpolation.

The scan optimization module 120 and/or the scanning application 130 may identify one or more blind spots in the breast. For example, the scan optimization module 120 may use four points to generate the cross section, skipping vertices between the nipple base and nipple top. In another example, the scan optimization module 120 may identify one or more blind spots in areas where there is a lack of contour information, nipple edge and base edge contours are assumed to be approximately planar.

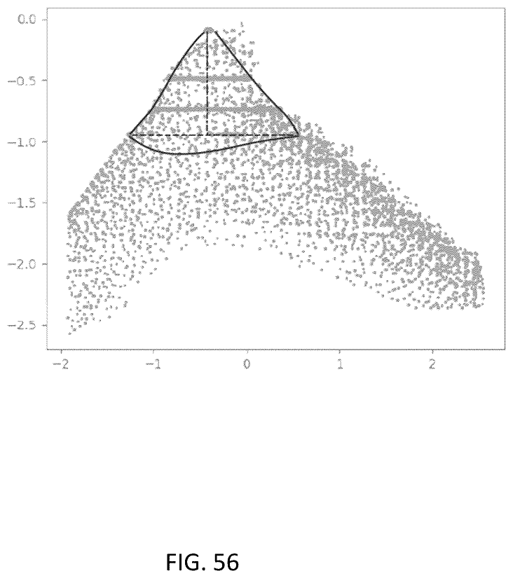

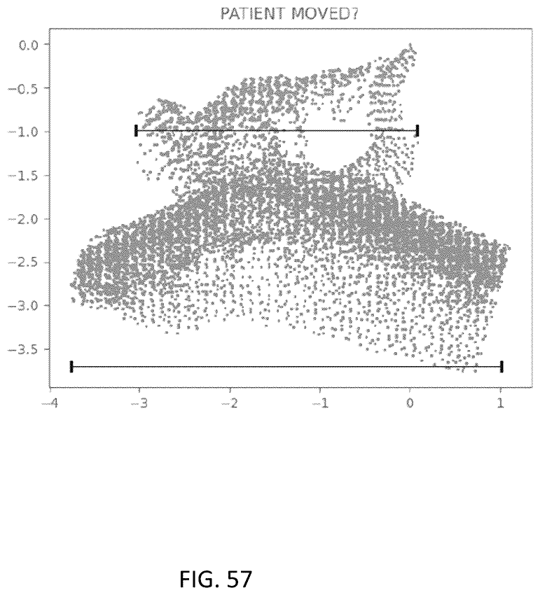

FIG. 57 shows noise.

Movement—excessive noise.

During scanning, a filter of the scan optimization module 120 and/or the scanning application 130 may be made to identify poor quality scans due to movement such as, for example, if excessive nipple movements cause distortion and/or an unreadable file.

Movement—excessive noise.

Excessive noise due to movement may result in a large apex area that is relatively unreadable. The scan optimization module 120 may measure top range of scan and compare it to the total footprint to determine if the user and/or the client device 104 moved during the scan.

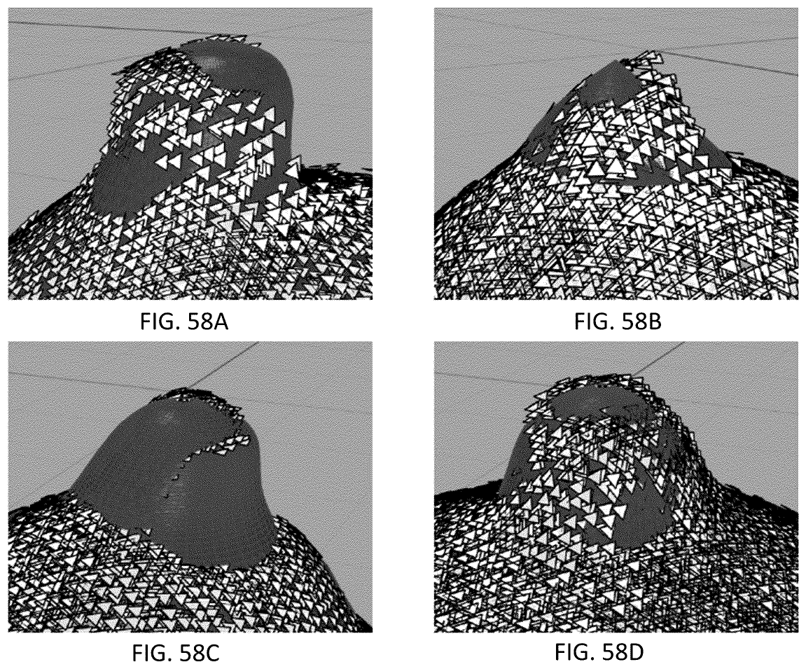

FIG. 58A-58D shows simplification. The scan optimization module 120 may clean up noise and make important measurements that result in a measurable simplification from the original point cloud scan. In some embodiments, the point cloud scan without noise may be accurate to less than 0.05 mm. By measuring the average displacement between points on the replicated nipple and the point cloud, the scan optimization module 120 may identify simplification measurements of the scan of the breast and/or nipple. For example, simplification measurements may indicate that the algorithm produces results that do not deviate from the original scan by more than an average of 1 mm. Since example nipple diameters may range between 10 mm-25 mm, small deviations are indicative of accuracy and success. The scan optimization module 120 may identify the color of the mouthpiece. The scan optimization module 120 may merge the images with other measurements and/or algorithms for obtaining shape.

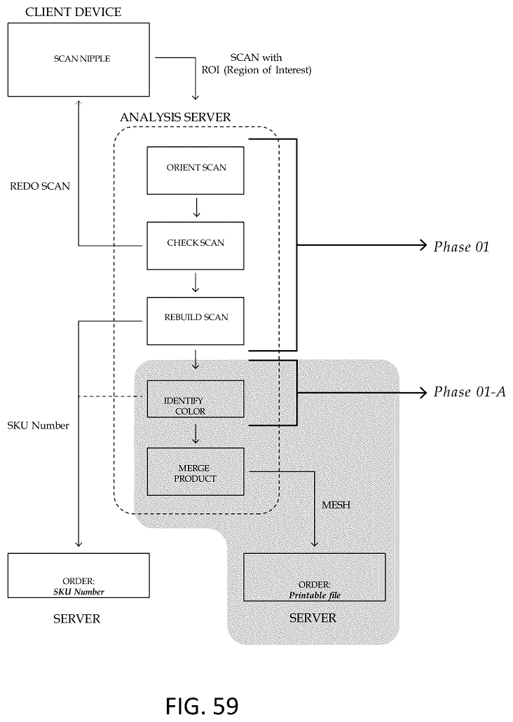

FIG. 59 shows a flow chart. The scanning application 130 may transmit, the scan optimization module 120, a scan as a .PLY file and 8 points defining the region of interest around the nipple. The scan optimization module 120 may process the user input in one or more of the following steps: orienting the scan, checking the scan, rebuilding the scan, returning a product. After one or more steps are completed successfully, server 106 may return a SKU corresponding with the final product.

If scan is good, then proceed. In some embodiments, if scan not good, then use default nipple profile since if user failed to scan first time, they might fail again and get frustrated. In some embodiments, if scan not good, then ask user to rescan.

Describe sending two files—POI and depth image from phone to server—sending 2 files.

Describe example that depth image is a collection of 68-70 images.

In some embodiments, if depth was not generated, then generate analysis on another file, such as the just the image. For example, generate analysis based on .ply file. This can be broader than making analysis based on .ply and depth image.

In some embodiments, server/application performs analysis based on .ply file and position measurements (e.g., from gyroscope) of the phone. (e.g., no depth image)

In some embodiments, server/application performs analysis based on .ply file and the depth image.

In some embodiments, server/application performs analysis based on .ply file and position measurements (e.g., from gyroscope) of the phone. (e.g., no depth image)1

High Dimensional Space may be a collection of vectors with An dimensions. The scan optimization module 120 and/or the scanning application 130 may process data points and tensors with thousands of parameters.

Encoding may be a simplified representation of a high dimensional data point.

Latent Space may also be known as a latent feature space or embedding space, and may be an embedding of a set of items within a manifold in which items resembling each other are positioned closer to one another in the latent space.

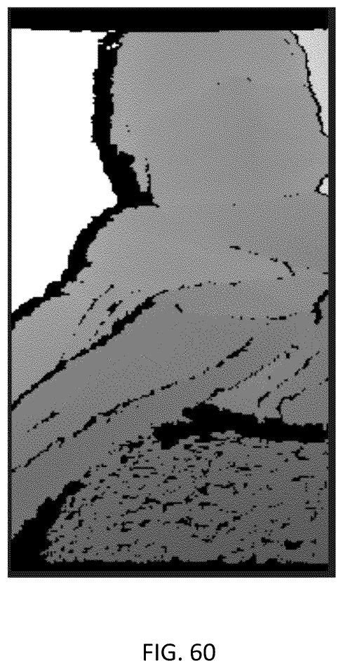

FIG. 60 shows a depth image. FIG. 60 shows that, using the camera 110 (e.g., lidar, phone camera, and/or stereo cameras), module the scan optimization module 120 and/or the scanning application 130 may create depth image. The scan optimization module 120 may receive the depth images labeled so that they may be used to train a neural network of the machine learning engine 144. The scan optimization module 120 may save the raw depth data saved anywhere that is not stored in the JPG format. The scan optimization module 120 may generate or utilize a depth map or depth image, which may be a pixel grid with depth dimensions. The scan optimization module 120 may normalize the position of the points and give a common axis to measure depth along. The scan optimization module 120 may standardize the scan results to make consistent and accurate comparisons between data points. In some embodiments, the scan optimization module 120 may reject the depth image. For example, the scan optimization module 120 may reject the depth map if the nipple is not identifiable in the depth image. In some embodiments, if the depth image is rejected, the scan optimization module 120 may perform the analytics described herein based on the 3D image. In some embodiments, if the depth image is rejected, the scan optimization module 120 may request the scanning application to rescan the user's breast.

In some embodiments, no depth image is generated/detected, so the most common shape is recommended to the user. For example, the user might be recommended the most common 80-90 mm nipple.

The user may be notified that no depth image was able to be generated. In another example, the user is not notified and simply recommended the depth image.

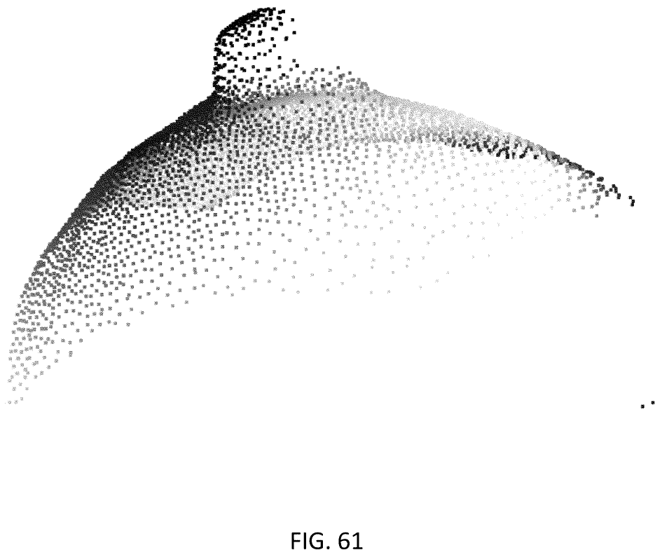

FIG. 61 shows received raw point clouds that may be received from the scanning application 130 by the scan optimization module 120. The scan optimization module 120 and/or the scanning application 130 may generate point clouds from depth maps. The point clouds may be collections of vectors that contain depth and positional information.

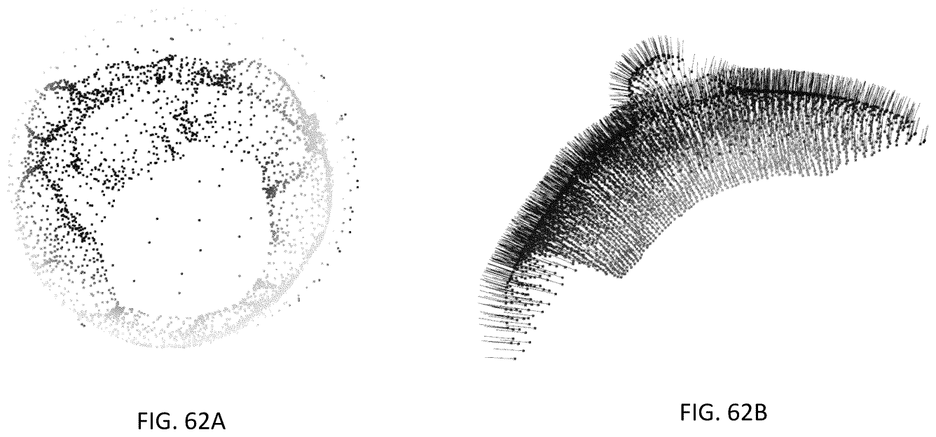

FIG. 62 shows that each line is a three-dimensional vector (x, y, z). These vectors may contain unitized values that represent the orientation of the surface at a given point. For example, facing up in the y axis would be represented as (0,1,0) The scan optimization module 120 and/or the scanning application 130 may identify important information about the curvature and rate of change across the surface. These may also be represented as points. This allows for fast comparisons between collections of surface normals.

surface normals are compared to make differences, and inferences that reduce dimensionality.

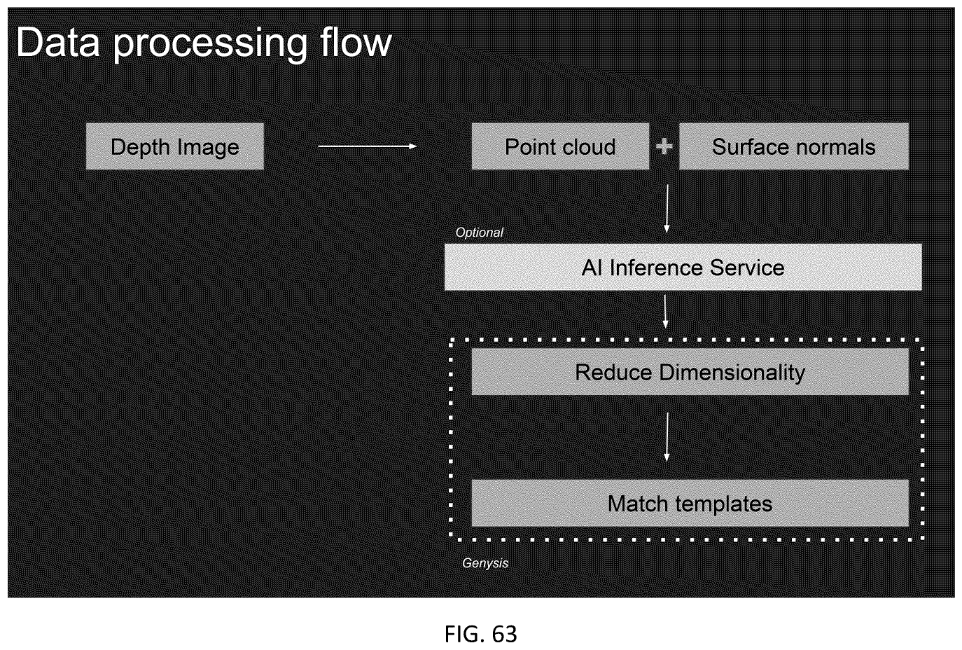

FIG. 63 shows the data processing flow to produce three-dimensional data from a depth image.

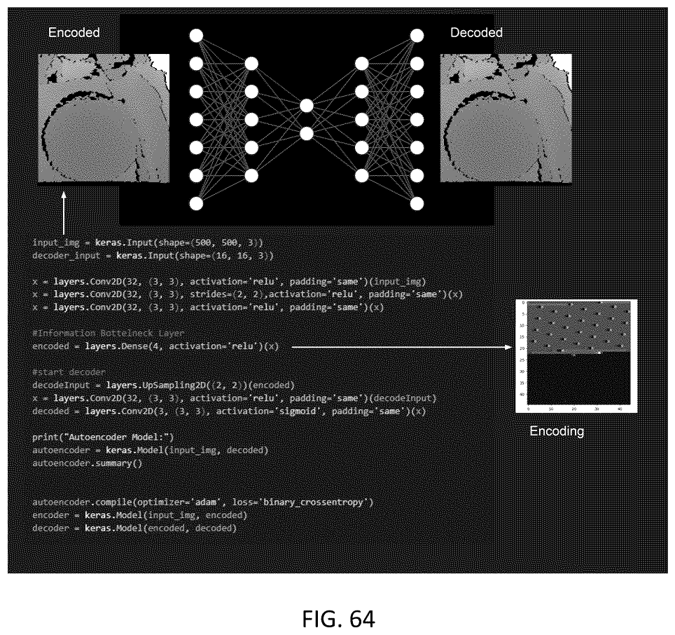

FIG. 64 shows autoencoder explored as a possible technique to reduce complex depth image data (500×500×3) into a simplified representation of (50×50) parameters. Algorithms may be trained to take an input reduce it down a minimized representation then reconstruct the image. Features may be retained in the encoding and may he used to make a comparison between the depth image data and the simplified representation. The results based on the depth data. However, the scan optimization module 120 may correct with minimal effort and the processing time would be around five seconds.

Example autoencoder processing (e.g., identifying nipple shape from scan) is 3-7 seconds. Example processing time for encoding may be 3-4 seconds. Example match to template may be 1-2 seconds.

If the analysis time is reduced (e.g., to 1 second), the application may simply add a delay for GUI purposes. In some embodiments, application adds delay before outputting scan result. For example, if the application/server identifies the nipple shape and is ready to output the shape within 1 second, it may look flimsy/clunky in the GUI and unrefined that such an intimate analysis of a mother's nipple. The application can add a 3-4 second delay before outputting the nipple shape to make it appear in the GUI that the intimate analysis of the nipple takes 5 seconds before returning the nipple shape.

Autoencoder may be an artificial neural network used to learn efficient coding of unlabeled data.

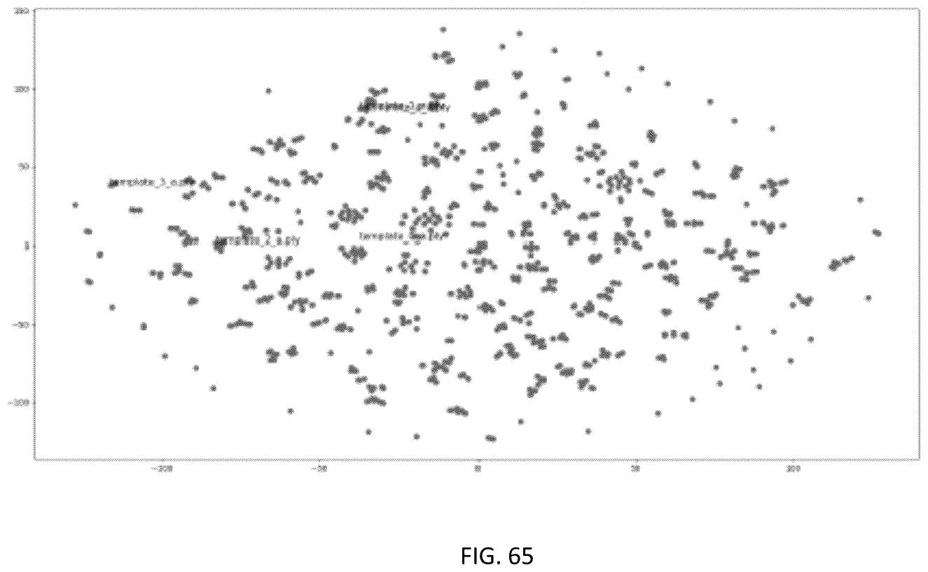

FIG. 65 illustrates the application of t-distributed stochastic neighbor embedding (TSNE), a technique typically used for visualizing high dimensional data. In this case we are using it as a dimensionality reduction technique. Distributions are matched between each scan and template to create a two-dimensional embedding. The algorithm module 140 may be fast. Example processing time may be 1-2 seconds.

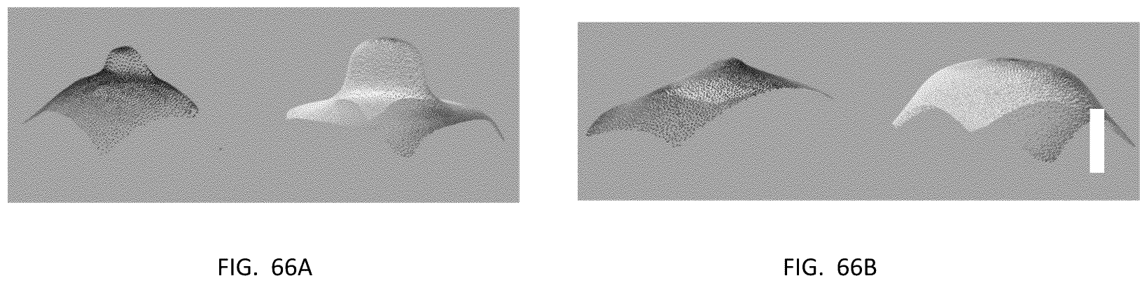

FIGS. 66A and 66B show that both point cloud data and surface normal information may be used as an initial input to refine results. Each point may then be compared to the closest point on the “target” I distance calculated between each point and normal vector. The values may be summed, and similarity score is calculated. For example, once the number of points being evaluated is reduced to ˜2000, the algorithm module 140 may operate quickly. Further dimensionality reduction may improve speed and accuracy. Example processing time may be 0.1 to 0.5 seconds. The scan optimization module 120 may match the scan or depth data to a template in a very fast and accurate by analyzing the scan data in aggregate and eliminate the steps being taken to extract specific feature information such as diameters and heights from the point clouds. The scan optimization module 120 and/or the scanning application 130 may perform analysis without AI using only the machine learning techniques outlined in technique #2. Using AI may improve the accuracy and enable more control over what features are used to match templates. TSNE and the template matching may result in fast processing speed of 1 to 2 seconds. The algorithm module 140 may include a template matching algorithm. For example, the template may be a predetermined bottle 103 with a matching mouthpiece and color.

The scan optimization module 120 and/or the scanning application 130 may include annotated depth data without compression artifacts for retraining the autoencoder.

The scan optimization module 120 and/or the scanning application 130 may receive feedback relating to what constitutes a good match to further refine the matching algorithms.

When scanning with the client device 104, the scan optimization module 120 and/or the scanning application 130 may analyze the yaw, pitch, and roll, so may get the nipple dimensions with a single depth image more accurately. Testing passing a depth map with the scan as a different method to get better accuracy.

For the scan, the scan optimization module 120 and/or the scanning application 130 may compare the point clouds of the scans against the point clouds of the template files. The scan optimization module 120 may base technique on distance based on measuring similarity between two sets of points. For example, two sets of points that represent two different shapes, such as a square and a rectangle. The scan optimization module 120 may identify distance similarity of two shapes by calculating the average distance between each point in one set and its nearest neighbor in the other set. The scan optimization module 120 may use the distance similarity to calculate a similarity score for each template. The scan optimization module 120 may calculate the similarity score based on both global cartesian coordinates and with surface normal. The scan optimization module 120 may balance and/or weigh these variables in the similarity score. Based on those scores, scan optimization module 120 may select the bottle 103 with the most similar mouthpiece and/or color for the user.

In some embodiments, compare the scan to one of five predetermined nipple shapes.

In some embodiments, user inputs that their nipple scan is of their nipple before they started breastfeeding/pregnant, so the nipple can be recommended based on how the mom's nipple is predicted to change when they start breastfeeding/give birth. In some embodiments, the recommended nipple can be the most popular nipple shape.

Examples of nipple dimensions include 15, 17, 19, 21, 23 mm. In some embodiments, to keep things simple for GUI, the nipples can be referred to as nipple 1, nipple 2, nipple 3, nipple 4, nipple 5.

In some embodiments, measure length of nipple and identifying closest nipple. In some embodiments, recommend two nipple shapes to the mother. For example, mother can receive the two closest nipple shapes for her baby to try.

When scanning with the client device 104, the scanning application 130 may identify the yaw, pitch, and/or roll of the client device 104. The scanning application 130 may transmit the yaw, pitch, and/or roll to the scan optimization module 120. The scan optimization module 120 may adjust the position of the scan to match the sample nipples. The scan optimization module 120 may pass or generate a depth map to position the nipple accurately.

While several embodiments of the present invention have been described, it is understood that these embodiments are illustrative only, and not restrictive, and that many modifications may become apparent to those of ordinary skill in the art, including that the inventive methodologies, the inventive systems, and the inventive devices described herein may be utilized in any combination with each other. Further still, the various steps may be carried out in any desired order (and any desired steps may be added and/or any desired steps may be eliminated).

What is claimed is:

1. A method comprising:
receiving, by one or more processors, from a camera, at least one image of a body part;
generating, by the one or more processors, a plurality of data points that each include depth and positional information of a point on the body part in the at least one image;
generating, by the one or more processors, a three-dimensional (3D) model of the body based at least in part on the plurality of data points;
determining, by the one or more processors, at least one portion of the 3D model having at least one error based at least in part on the plurality of data points;
modifying, by the one or more processors, the plurality of data points to rebuild the 3D model with at least one rebuilt portion in place of the at least one portion having the at least one error.

2. The method of claim 1, further comprising:
applying, by the one or more processors, a marching cubes algorithm to rebuild the 3D model.

4. The method of claim 1, further comprising:
causing, by the one or more processors, a client device comprising the camera to display the at least one image; and
generating, by the one or more processors, an indicator to indicate a region of interest including the body part in the plurality of images of the at least one image.

5. The method of claim 1, further comprising:
causing, by the one or more processors, a client device comprising the camera to display the at least one image; and
generating, by the one or more processors, responsive to not detecting the body part in the at least one image, a notification requesting a user to maneuver the camera.

6. The method of claim 1, further comprising:
transmitting, by the one or more processors, to a body part analysis server, the plurality of data points; and
receiving, by the one or more processors, from the body part analysis server, a fitment category and/or a color to produce a user-specific fitment fitted to the body part in the at least one image.

7. The method of claim 1, further comprising:
generating, by the one or more processors, at least one notification to a client device, the at least one notification comprising:
indicating the at least one error in the at least one portion, and
an instruction to retake the at least one image.

8. The method of claim 1, wherein the 3D model comprises a point cloud.

9. The method of claim 1, wherein the at least one error comprises at least one of:
noise,
at least one blind spot, or
at least one measurement error.

10. The method of claim 1, further comprising:
generating, by the one or more processors, an outline of the 3D model along a lateral profile of the body part; and
rebuilding, by the one or more processors, the at least one portion of the 3D model by rotating the outline around the 3D model to define the lateral profile at the at least one portion.

11. A system comprising:
receive, from a camera, at least one image of a body part;
generate a plurality of data points that each include depth and positional information of a point on the body part in the at least one image;
generate a three-dimensional (3D) model of the body based at least in part on the plurality of data points;
determine at least one portion of the 3D model having at least one error based at least in part on the plurality of data points; and
modify the plurality of data points to rebuild the 3D model with at least one rebuilt portion in place of the at least one portion having the at least one error.

12. The system of claim 11, wherein the at least one processor is further configured to:
apply a marching cubes algorithm to rebuild the 3D model.

14. The system of claim 11, wherein the at least one processor is further configured to:
cause, a client device comprising the camera to display the at least one image; and
generate, an indicator to indicate a region of interest including the body part in the plurality of images of the at least one image.

15. The system of claim 11, wherein the at least one processor is further configured to:
cause, a client device comprising the camera to display the at least one image; and
generate, responsive to not detecting the body part in the at least one image, a notification requesting a user to maneuver the camera.

16. The system of claim 11, wherein the at least one processor is further configured to:
transmit, to a body part analysis server, the plurality of data points; and
receive, from the body part analysis server, a fitment category and/or a color to produce a user-specific fitment fitted to the body part in the at least one image.

17. The system of claim 11, wherein the at least one processor is further configured to:
generate at least one notification to a client device, the at least one notification comprising:
indicating the at least one error in the at least one portion, and
an instruction to retake the at least one image.

18. The system of claim 11, wherein the 3D model comprises a point cloud.

19. The system of claim 11, wherein the at least one error comprises at least one of:
noise,
at least one blind spot, or
at least one measurement error.

20. The system of claim 11, wherein the at least one processor is further configured to:
generate an outline of the 3D model along a lateral profile of the body part; and
rebuild the at least one portion of the 3D model by rotating the outline around the 3D model to define the lateral profile at the at least one portion.
